(19) United States
(12) Patent Application Publication
(10) Pub. No.: US 2025/0178624 A1
(43) Pub. Date: Jun. 5, 2025

(54) SPEECH-BASED VEHICULAR CONTROL

(71) Applicant: QUALCOMM Incorporated, San Diego, CA (US)

(72) Inventors: Venkatraman NARAYANAN, Farmington Hills, MI (US); Varun RAVI KUMAR, San Diego, CA (US); Senthil Kumar YOGAMANI, Headford (IE)

(21) Appl. No.: 18/526,803

(22) Filed: Dec. 1, 2023

(51) Int. Cl. B60W 50/10; B60W 10/10; B60W 10/18; B60W 10/20; B60W 50/14; B60W 60/00

(52) U.S. Cl. CPC B60W 50/10; B60W 10/10; B60W 10/18; B60W 10/20; B60W 50/14; B60W 60/0015; B60W 2420/408; B60W 2420/54; B60W 2540/21

(57) ABSTRACT

A device includes memory configured to store scene data from one or more scene sensors associated with a vehicle. The device also includes one or more processors configured to obtain, via a first machine-learning model of a contextual encoder system, a first embedding based on data representing speech that includes one or more commands for operation of the vehicle. The one or more processors are configured to obtain, via a second machine-learning model of the contextual encoder system, a second embedding based on the scene data and based on state data of the first machine-learning model. The one or more processors are configured to generate one or more vehicle control signals for the vehicle based on the first embedding and the second embedding.

### I. FIELD

The present disclosure is generally related to control of a vehicle using speech.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

In addition to general purpose computing devices, such as tablets and smart phones, these smaller and more powerful computing devices have found use in more specialized applications, such as within vehicles. For example, it is increasingly common for control systems of vehicles to include one or more processors that support functionality of the vehicle. In this example, many functions supported by processor(s) in a vehicle are hidden from users. To illustrate, engine controllers within a vehicle may use sensor data to control engine functions, such as fuel injection or valve timing. Other functions supported by the processor(s) are user-facing. To illustrate, many functions of an in-vehicle entertainment system may be supported by one or more processors. It can be challenging to integrate processor(s) and user-facing interfaces into a vehicle in a manner that improves the user's control of the vehicle without introducing distractions.

### III. SUMMARY

According to one implementation of the present disclosure, a device includes memory configured to store scene data from one or more scene sensors associated with a vehicle. The device also includes one or more processors configured to obtain, via a first machine-learning model of a contextual encoder system, a first embedding based on data representing speech that includes one or more commands for operation of the vehicle. The one or more processors are configured to obtain, via a second machine-learning model of the contextual encoder system, a second embedding based on the scene data and based on state data of the first machine-learning model. The one or more processors are configured to generate one or more vehicle control signals for the vehicle based on the first embedding and the second embedding.

According to another implementation of the present disclosure, a method includes obtaining, via a first machine-learning model of a contextual encoder system, a first embedding based on data representing speech that includes one or more commands for operation of a vehicle. The method also includes obtaining, via a second machine-learning model of the contextual encoder system, a second embedding based on scene data from one or more scene sensors associated with the vehicle and based on state data of the first machine-learning model. The method also includes generating one or more vehicle control signals for the vehicle based on the first embedding and the second embedding.

According to another implementation of the present disclosure, a non-transitory computer-readable medium stores instructions executable by one or more processors to cause the one or more processors to obtain, via a first machine-learning model of a contextual encoder system, a first embedding based on data representing speech that includes one or more commands for operation of a vehicle. The instructions further cause the one or more processors to obtain, via a second machine-learning model of the contextual encoder system, a second embedding based on scene data from one or more scene sensors associated with the vehicle and based on state data of the first machine-learning model. The instructions further cause the one or more processors to generate one or more vehicle control signals for the vehicle based on the first embedding and the second embedding.

According to another implementation of the present disclosure, an apparatus includes means for obtaining, via a first machine-learning model of a contextual encoder system, a first embedding based on data representing speech that includes one or more commands for operation of a vehicle. The apparatus includes means for obtaining, via a second machine-learning model of the contextual encoder system, a second embedding based on scene data from one or more scene sensors associated with the vehicle and based on state data of the first machine-learning model. The apparatus includes means for generating one or more vehicle control signals for the vehicle based on the first embedding and the second embedding.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system including a speech command contextualizer for control of a vehicle, in accordance with some examples of the present disclosure.

FIG. 2 is a block diagram of an example of a particular illustrative aspect of the system of FIG. 1, in accordance with some examples of the present disclosure.

FIG. 3 is a block diagram of another example of a particular illustrative aspect of the system of FIG. 1, in accordance with some examples of the present disclosure.

FIG. 4 is a block diagram of a detailed example of a particular illustrative aspect of the system of FIG. 1, in accordance with some examples of the present disclosure.

FIG. 5 is a diagram of an example of an integrated circuit that includes the speech command contextualizer, in accordance with some examples of the present disclosure.

FIG. 6 is a diagram of a mobile device that includes the speech command contextualizer, in accordance with some examples of the present disclosure.

FIG. 7 is a diagram of a headset that includes the speech command contextualizer, in accordance with some examples of the present disclosure.

FIG. 8 is a diagram of a wearable electronic device that includes the speech command contextualizer, in accordance with some examples of the present disclosure.

FIG. 9 is a diagram of a voice-controlled speaker system that includes the speech command contextualizer, in accordance with some examples of the present disclosure.

FIG. 10 is a diagram of a camera that includes the speech command contextualizer, in accordance with some examples of the present disclosure.

FIG. 11 is a diagram of a mixed reality or augmented reality glasses device that includes the speech command contextualizer, in accordance with some examples of the present disclosure.

FIG. 12 is a diagram of earbuds that includes the speech command contextualizer, in accordance with some examples of the present disclosure.

FIG. 13 is a diagram of a headset, such as a virtual reality, mixed reality, or augmented reality headset that includes the speech command contextualizer, in accordance with some examples of the present disclosure.

FIG. 14 is a diagram of a first example of a vehicle that includes the speech command contextualizer, in accordance with some examples of the present disclosure.

FIG. 15 is a diagram of a second example of a vehicle that includes the speech command contextualizer, in accordance with some examples of the present disclosure.

FIG. 16 is a diagram of a particular implementation of a method of controlling a vehicle based on speech commands that may be performed by the system of FIG. 1, in accordance with some examples of the present disclosure.

FIG. 17 is a block diagram of a particular illustrative example of a device that includes the speech command contextualizer, in accordance with some examples of the present disclosure.

### V. DETAILED DESCRIPTION

Aspects disclosed herein improve operation of a vehicle by enabling a user to control operation of the vehicle using unstructured, natural-language speech commands that are context specific. Although some vehicles may be able to accept very structured voice instructions from a user (such as instructions to find a route to a specified location), these vehicles lack the ability to understand complex and/or unstructured voice commands, which limits their utility for real-world scenarios. For example, such vehicles cannot integrate context-specific voice commands, such as “turn after the second blue house”, with appropriate scene data in order to follow such commands.

Aspects of the present disclosure solve these and other problems by enabling a vehicle to act on context-specific, natural-language voice commands. For example, a disclosed system uses machine-learning techniques to co-process scene data representative of an environment around the vehicle and voice instructions from a user. Such co-processing enables the system to understand and act on the context and intent behind the voice instructions. This contextual understanding enables the vehicle to respond to complex commands, such as commands specific to the context in which the vehicle is operating and to take appropriate actions based on the current driving situation, traffic conditions, and other relevant factors.

Particular aspects of a system to provide the above-described benefits and solutions to problems faced by autonomous vehicles are directed to accurate interpretation and understanding of voice instructions provided by human users. Such aspects solve problems such as how to accurately recognize and extract meaningful information from natural-language speech, accounting for variations in pronunciation, accent, and language nuances of the speech. In some embodiments, the system uses techniques such as speech-to-text processing to generate text based on the speech, and language models (e.g., one or more transformer encoders, other natural language processing models, or both) to encode the text to generate text features representing the speech.

Additional aspects of the system to provide the above-described benefits and solutions to problems faced by autonomous vehicles are directed to contextual understanding, which includes scene recognition (e.g., accurately recognizing a current operating environment of the vehicle) and contextual understanding of the voice instructions in view of the scene. Such aspects solve problems such as how to interpret commands that are context-specific and provided in natural language and how to safely and appropriately act on the commands in view of the scene (e.g., based on the current driving situation, traffic conditions, and other relevant factors). In some embodiments, the system uses co-processing of text features and scene features to enable contextual understanding and scene recognition. For example, text features are processed by a first machine-learning model to determine a first embedding (e.g., a semantic embedding) that represents objects identified in the speech and actions identified in the speech, and the scene features are processed by a second machine-learning model to determine a second embedding (e.g., a text-grounded scene embedding) that represents objects identified in the speech within the scene data. In this example, the first and second machine-learning models share intermediate state data with one another such that the content and processing of the text features affects the text-grounded scene embedding generated by the second machine-learning model and the scene data affects the semantic embedding generated by the first machine-learning model. Thus, the text-grounded scene embedding and the semantic embedding are each relevant to the scene in which the vehicle is operating and relevant to the content of the speech. Such co-processing enables the system to better understand the environment and to interpret commands within the context of the current operating environment of the vehicle. This allows for more accurate and context-aware navigation updates, enhancing the system's adaptability to various driving scenarios.

While co-processing enables generation of a semantic embedding that is relevant to the scene and generation of a scene embedding (e.g., the text-grounded scene embedding) that is relevant to the speech, scene data and speech data nevertheless represent different data modalities in which meaningful comparison and analysis is problematic. Additional aspects of the system solve this problem by projecting one or both of the embeddings into a shared embedding space. For example, the semantic embedding, the text-grounded scene embedding, or both, can be processed by a projection model to align the embeddings in a shared feature space for subsequent analysis. In this example, the aligned semantic and text-grounded scene embeddings can be combined (e.g., concatenated) to generate a navigation embedding that represents both aspects of the scene that are relevant to the speech and aspects of the speech that are relevant to the scene, thereby enabling subsequent analysis of scene and speech to generate vehicle control signals.

Additional aspects of the system are directed to the problem of safe operation of the vehicle. Such aspects solve problems such as how to ensure that execution of spoken commands does not compromise safety, violate traffic rules, or pose risks to passengers, pedestrians, or other vehicles on the road. In some embodiments, the system pre-screens the navigation embedding before providing the navigation embedding to a self-driving control pipeline of the vehicle. In some such embodiments, the pre-screening is performed using a safety mask generated by a transformer decoder based on the navigation embedding. In such embodiments, the safety mask is context specific. The transformer decoder used to generate the safety mask can optionally receive feedback from the self-driving control pipeline to enable online modification of the transformer decoder to improve safety pre-screening.

Additional aspects of the system to provide the above-described benefits and solutions to problems faced by autonomous vehicles are directed to path planning responsive to spoken commands. Such aspects solve problems such as how to adjust operation of the vehicle (e.g., trajectory, speed, lane changing, alerting other vehicles and bystanders of intended future actions, and other driving parameters) to align with the user's voice guidance while ensuring safety and compliance with traffic regulations. In some embodiments, the system uses techniques such as generating a path plan for the vehicle based on the masked navigation feature embedding (e.g., using a feedforward neural network, such as a multilayer perceptron).

In addition to the benefits of individual aspects described above, overall, the system disclosed herein provides benefits such as real-time, natural language spoken control of a vehicle. Such benefits are provided by enabling real-time, context-aware processing of spoken commands, and integrating such processing with a self-driving control pipeline of a vehicle. Traditional sensors associated with a self-driving control pipeline, such as cameras, lidar sensors, traffic sensors, radar, etc. can be used to facilitate contextual awareness, contextual understanding of spoken commands, and real-time vehicle control. This integration provides an improved user experience by enabling voice-guided navigation and vehicle control in a natural and intuitive way, which eliminates the need for manual input or complex interfaces. For example, a user's voice instructions can convey more nuanced and complex information compared to simple commands or structured commands. Thus, the user can provide instructions in a manner that allows for more flexible and personalized navigation and vehicle control. This improved interaction will also allow users to feel more in control and to develop a sense of comfort with self-driving vehicles, enhancing user trust and adoption. Additionally, the simplified and improved user interaction may facilitate use by a wider range of users. For example, users with disabilities can face difficulties with providing manual input, which the disclosed systems solve by enabling voice input.

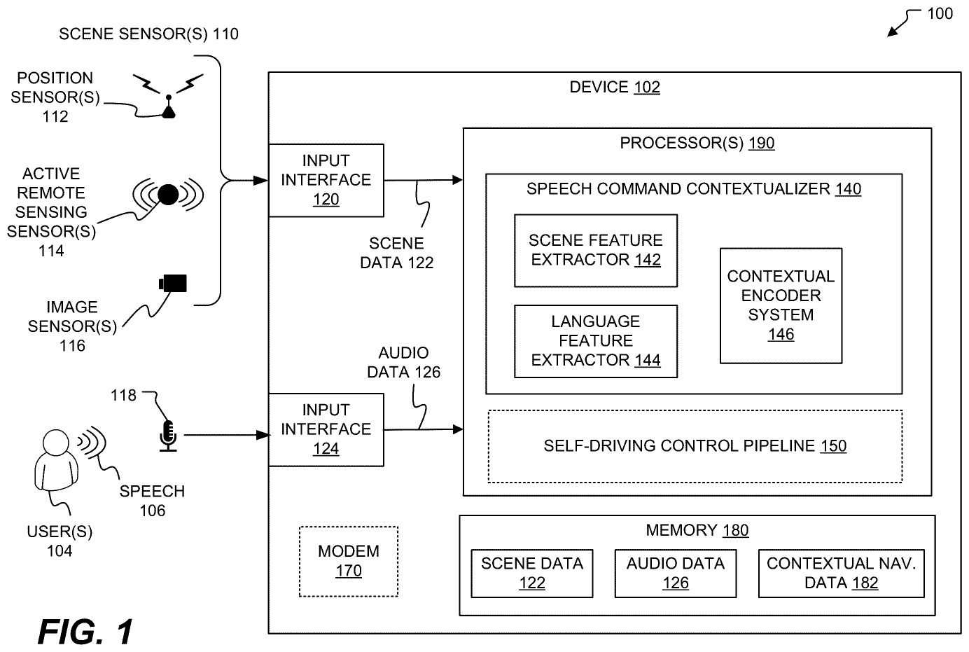

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor 190 and in other implementations the device 102 includes multiple processors 190. For ease of reference herein, such features are generally introduced as “one or more” features and are subsequently referred to in the singular or optional plural (as indicated by “(s)”) unless aspects related to multiple of the features are being described.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an embodiment, and/or an aspect, and should not be construed as limiting or as indicating a preference or a preferred embodiment. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some embodiments, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows-a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some embodiments, a model may be continuously, periodically, or occasionally updated, in which case training time and runtime may be interleaved or one version of the model can be used for inference while a copy is updated, after which the updated copy may be deployed for inference.

In some embodiments, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning, a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 illustrates an example of a system 100 that is operable to generate vehicle control signals for a vehicle based on spoken commands and a context of the vehicle. The system 100 includes a device 102, which includes an input interface 120 configured to receive scene data 122 from one or more scene sensors 110 and an input interface 124 configured to receive audio data 126 from one or more microphones 118. The scene data 122 represents a context of the vehicle, and at least a portion of the audio data 126 can include data representing speech 106 from one or more users 104 associated with the vehicle (e.g., a vehicle operator, a vehicle passenger, etc.). The speech 106 can include one or more commands for operation of the vehicle. In some embodiments, the device 102 includes, is included within (e.g., is integrated within), or corresponds to the vehicle. In other embodiments, the device 102 is separate from the vehicle and configured to communicate with the vehicle (e.g., via a modem 170 of the device 102).

The device 102 includes one or more processors 190 coupled to the input interfaces 120, 124, a memory 180, and optionally the modem 170. The processor(s) 190 include a speech command contextualizer 140. The speech command contextualizer 140 is configured to use various machine-learning techniques to process the audio data 126 and the scene data 122 to generate contextual navigation data 182. In a particular aspect, the contextual navigation data 182 includes, corresponds to, or is included within embedding data, also referred to herein as an embedding. In the context of machine-learning, an embedding refers to a set of values (e.g., a vector of floating-point values) that characterize represented data as a location in a high-dimensional feature space.

In FIG. 1, the speech command contextualizer 140 includes a scene feature extractor 142, a language feature extractor 144 and a contextual encoder system 146. As explained in more detail below, the scene feature extractor 142 is configured to generate scene feature data representing the scene data 122, and the language feature extractor 144 is configured to generate linguistic feature data based on speech content of the audio data 126. The contextual encoder system 146 is configured to process the scene feature data and the linguistic feature data together to generate the contextual navigation data 182. The contextual navigation data 182 relates content of the speech 106 to features in an environment around the vehicle and related actions. For example, the speech 106 may specify an action to be taken by the vehicle based on an object that is present in the environment. In this example, the contextual navigation data 182 can include information that represents the action and the object, as well as spatial information relating the object and the vehicle. To illustrate, the scene data 122 can include image data captured by one or more image sensors 116 associated with the vehicle, and the speech 106 can include a command to “turn left after the yellow truck”. In this illustrative example, the contextual navigation data 182 represents the speech 106 and the scene data 122 in an embedding that includes information about the action to be performed (e.g., turn left), ties the action to a context object (e.g., the yellow truck), and maps a location of the object to the scene data 122 (e.g., identifies pixels representing the yellow truck).

The specific configuration and training of the scene feature extractor 142 depends on the types of scene sensor(s) 110 used to generate the scene data 122. In the example illustrated in FIG. 1, the scene sensor(s) 110 include one or more position sensors 112, one or more image sensors 116, one or more active remote sensing sensors 114, or a combination thereof. The position sensor(s) 112 can include or correspond to one or more navigation signal receivers, such as a Global Positioning System (GPS) receiver, a Galileo system receiver, a BeiDou system receiver, or a similar satellite or terrestrial position system receiver. Additionally, or alternatively, the position sensor(s) 112 can include inertial measurement sensors, dead reckoning sensors, or other sensors that individually or in combination with other information generate data indicating the spatial location (e.g., coordinate location) of the vehicle, an orientation of the vehicle, a trajectory of the vehicle, or other similar data. The orientation of the vehicle can be indicated relative to a global reference frame (e.g., magnetic North) or relative to a local reference frame (e.g., a lane position on a multilane roadway).

The image sensor(s) 116 can include cameras coupled to the vehicle or associated with the vehicle. For example, the image sensor(s) 116 can generate a time-series of images representing views in various directions around the vehicle (e.g., a front view, one or more side views, a rear view, or a combination thereof). In some embodiments, one or more of the image sensor(s) 116 are separate from the vehicle and arranged to capture images that include the vehicle and its context. To illustrate, image sensor(s) 116 can include a camera disposed at an intersection and capable of capturing images of the vehicle as the vehicle approaches or traverses the intersection.

The active remote sensing sensors 114 include sensors that transmit signals and sense portions of those signals (referred to as “returns”) reflected by nearby objects. “Active” in this context indicates that the active remote sensing sensors 114 include both transmission components and reception components that cooperate to sense the environment by transmitting and receiving signals. Thus, the term “active” in this context does not imply that the active remote sensing sensors 114 are in use or provided power at any specific time. Examples of active remote sensing sensors 114 include, without limitation, radar systems, sonar systems, and lidar systems.

The scene feature extractor 142 includes one or more machine-learning models configured to process (e.g., dimensionally reduce) image data and optionally position data to generate scene feature data. The image data can include two-dimensional (2D) image data, three-dimensional (3D) image data (such as a 3D point cloud), or both. As one example, the scene feature extractor 142 includes one or more convolution networks, one or more self-attention networks, or other trained models.

The language feature extractor 144 includes one or more machine-learning models configured to process the audio data 126 to generate the linguistic feature data. For example, the language feature extractor 144 can include one or more speech-to-text models configured to generate text representing speech content of the audio data 126, and one or more language models configured to process the text to generate text features, where the text features correspond to the linguistic feature data. To illustrate, the language feature extractor 144 includes one or more encoders of a self-attention network (e.g., a transformer network).

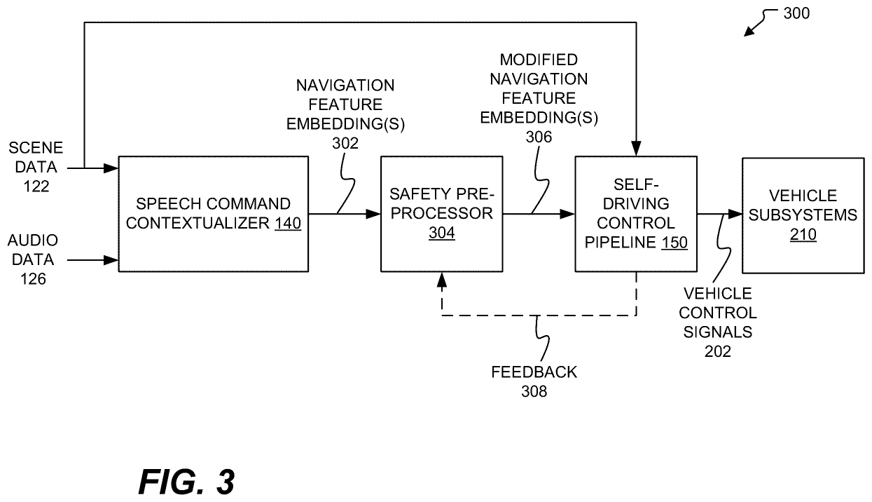

The contextual encoder system 146 includes one or more machine-learning models configured to process both the linguistic feature data and the scene feature data to generate the contextual navigation data 182. For example, in some embodiments, the contextual encoder system 146 includes a first machine-learning model that is configured to generate a first embedding based on data representing the speech 106 (e.g., the linguistic feature data, such as the text features) and a second machine-learning model configured to generate a second embedding based on the scene feature data. In some such embodiments, the first and second machine-learning models share intermediate state data such that the first embedding is based in part on the scene feature data, the second embedding is based in part on the speech 106, or both. For example, the first embedding can include a semantic embedding related to actions specified in the speech 106 and objects referenced in the speech 106 and detected in the scene data 122. As another example, the second embedding can include a text-grounded scene embedding (e.g., an image embedding grounded to objects referenced in the speech 106). In some embodiments, the contextual encoder system 146 includes a single machine-learning model that is configured and trained to generate first embedding based on data representing the speech 106 and a second embedding based on the scene feature data, or a single embedding representing both (e.g., the navigation feature embedding 302 of FIG. 3).

In embodiments in which the contextual encoder system 146 generates a first embedding related to the audio data 126 (e.g., the semantic embedding) and a second embedding related to the scene data 122 (e.g., the text-grounded scene embedding), the contextual encoder system 146 is configured to map the first and second embeddings to a shared feature space. For example, the contextual encoder system 146 can include one or more projection models to align the first and second embeddings to a shared space. In this example, the projection model(s) can include one or more feedforward fully connected networks configured to modify the dimensionality of the first embedding to generate an aligned first embedding in a feature space of the second embedding, can modify the dimensionality of the second embedding to generate an aligned second embedding in a feature space of the first embedding, or can modify the dimensionality of both the first embedding and the second embedding to generate aligned first and second embeddings in a common feature space. To illustrate, since the second embedding is based on the scene data 122 and the first embedding is based on the speech 106, the second embedding is likely to be higher dimensional than the first embedding, and the projection model(s) can be configured to dimensionally reduce the second embedding to align the second embedding to the feature space of the first embedding.

Continuing the example above, the contextual encoder system 146 is configured to combine the aligned first and second embeddings to generate the contextual navigation data 182. For example, the contextual navigation data 182 can include or correspond to a navigation feature embedding. In this example, the navigation feature embedding can include the first embedding combined with the aligned second embedding, the aligned first embedding combined with the second embedding, or the aligned first embedding combined with the aligned second embedding. The embeddings combined to generate the navigation feature embedding can be combined via concatenation, element-wise operations, or similar techniques.

In some embodiments, the speech command contextualizer 140 is configured to apply a contextual safety mask to the navigation feature embedding to generate the contextual navigation data 182. In such embodiments, the speech command contextualizer 140 includes one or more machine-learning models configured to generate the contextual safety mask based on the navigation feature embedding. For example, the navigation feature embedding can be provided as input to a mask generation network (e.g., a decoder of a transformer network) to generate the contextual safety mask. The contextual safety mask can be applied to the navigation feature embedding (e.g., element-by-element) to modify the navigation feature embedding to generate a masked navigation feature embedding. In this example, the masked navigation feature embedding corresponds to the contextual navigation data 182.

The device 102, the vehicle, or a combination thereof, includes a self-driving control pipeline 150 configured to generate one or more vehicle control signals for the vehicle based on the contextual navigation data 182. In some embodiments, the speech command contextualizer 140 and the self-driving control pipeline 150 are integrated into separate devices. For example, the speech command contextualizer 140 can be integrated into a mobile device (e.g., a smart phone) and the self-driving control pipeline 150 can be integrated into the vehicle. In such embodiments, the device 102 can send the contextual navigation data 182 (or other information generated by the speech command contextualizer 140) to the vehicle via the modem 170. In some embodiments, the self-driving control pipeline 150 is divided between two or more distinct devices. For example, a path planner of the self-driving control pipeline 150 can be integrated into the device 102 and configured to generate the path plan based on the contextual navigation data 182, and remaining portions of the self-driving control pipeline 150 can be integrated into a vehicle that is distinct from the device 102. In such embodiments, the device 102 can send the path plan, the vehicle control signals, or other information (e.g., the contextual navigation data 182) to the vehicle via the modem 170. In some embodiments, the device 102 includes, is included within, or corresponds to the vehicle, and one or more of the microphone(s) 118, one or more of the scene sensor(s) 110, or both, are integrated into a device distinct from the vehicle. For example, the microphone(s) 118 can be integrated into a mobile device (e.g., a smart phone), a wearable device, etc., and configured to send the audio data 126 to the modem 170 of the vehicle.

The self-driving control pipeline 150 includes one or more machine-learning models, one or more procedural models (e.g., control laws), or a combination thereof, that process the contextual navigation data 182 to generate the vehicle control signal(s). In some embodiments, the self-driving control pipeline 150 is arranged hierarchically or semi-hierarchically, such that higher-level plans are translated or mapped into lower-level tasks and eventually to actions performed by one or more individual vehicle systems. For example, the self-driving control pipeline 150 can generate a path plan for the vehicle based on the contextual navigation data 182, where the path plan indicates an intended route that the vehicle should follow. To illustrate, if the speech 106 includes a command to “turn left after the yellow truck” the path plan can indicate an intended route to be followed from a current location of the vehicle to near the yellow truck, a turn into a roadway, a parking lot, or another driving surface that is after the yellow truck along the intended route, and at least a portion of an intended route subsequent to the turn.

Additional machine-learning models, procedural models, or both, can process the path plan to determine tasks that are used to generate the vehicle control signals. For example, control laws can be applied to the path plan to determine individual tasks associated with following the path plan, such as when the vehicle should begin to slow down to execute the turn, when the vehicle should activate a turn indicator, etc. Some of these task may be further sub-divided. To illustrate, slowing the vehicle can be divided into a task of reducing actuation of the vehicle's accelerator and a task of applying the vehicle's brakes. Additionally, machine-learning models, procedural models, or both, can oversee multiple tasks or other aspects of the self-driving control pipeline 150. For example, one or more models can filter or modify output of other models to ensure compliance with traffic laws or safety regulations.

The individual tasks determined by the self-driving control pipeline 150 can be used to determine the vehicle control signals, which can be provided to controllers of various vehicle subsystems. To illustrate, one or more vehicle control signals can be provided to a brake subsystem to cause a brake controller to initiate braking. The vehicle control signal(s) can include, for example, maneuvering signals, vehicle alert and communication system signals, or both. Examples of maneuvering signals include steering control signals, brake control signals, transmission control signals, acceleration control signals, or a combination thereof. Examples of vehicle alert and communication system signals include turn indicator signals, brake light signals, horn signals, head light signals, other vehicle lighting signals, or a combination thereof.

Thus, the system 100 facilitates voice control of a vehicle based on natural-language speech (e.g., speech 106). Further, the natural-language speech can include commands that are context specific (e.g., related to the context in which the vehicle is operating), which greatly simplifies the burden on the user of the vehicle by enabling the user to provide commands to the vehicle in much the same way the user would provide instructions to a human driver. Further, as described in more detail below, in certain embodiments, the system 100 is arranged such that all of the various machine-learning models of the speech command contextualizer 140 and optionally of the self-driving control pipeline 150 can be trained together via conventional techniques, such as backpropagation, which simplifies generation of the models and updating of the models.

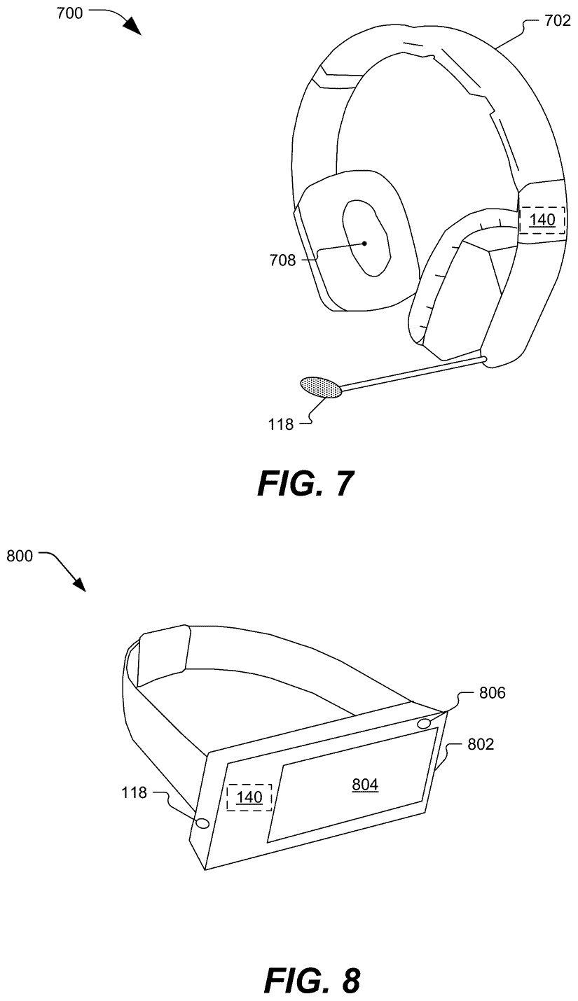

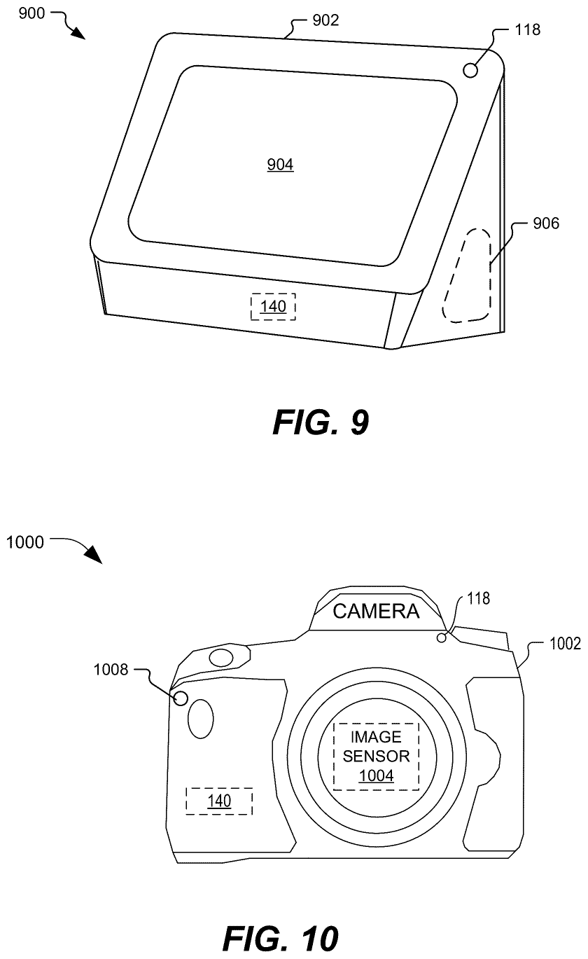

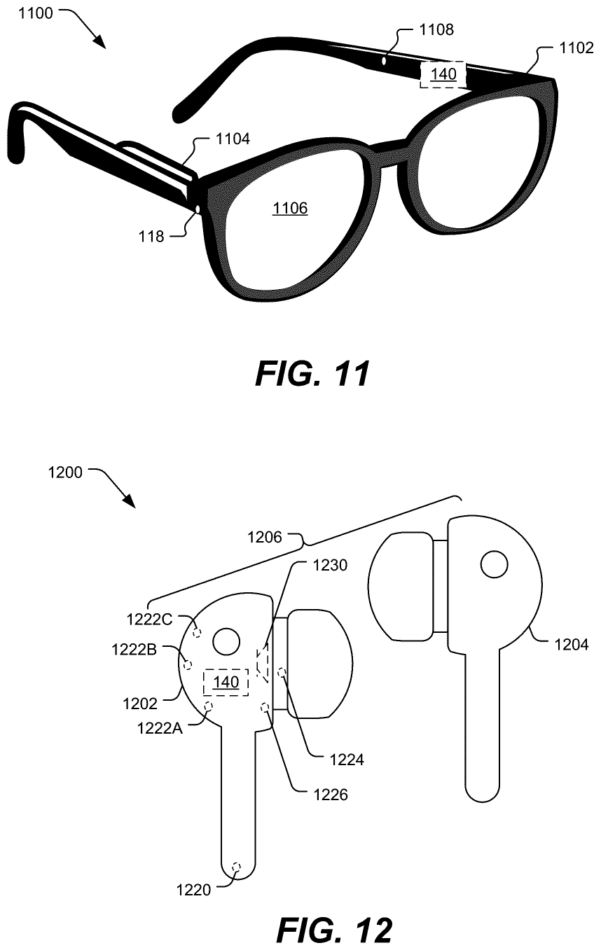

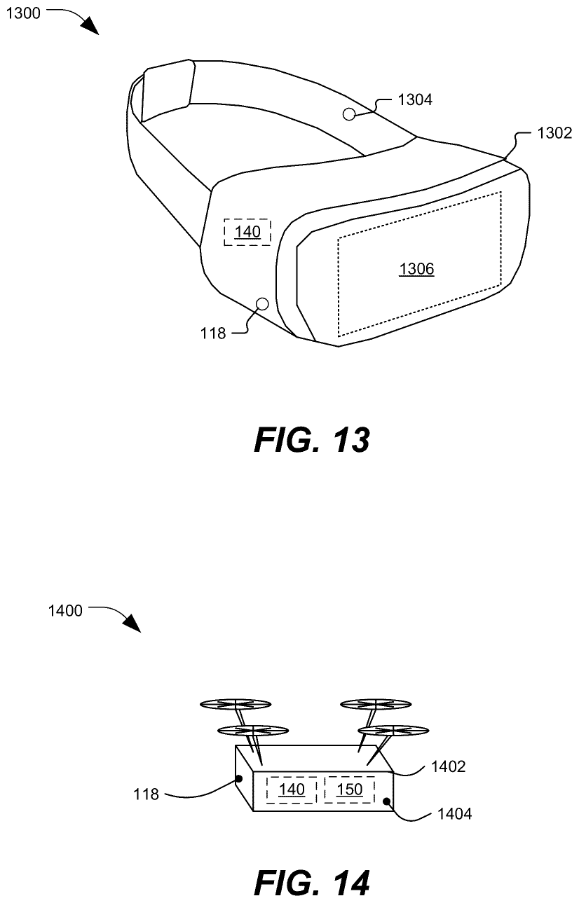

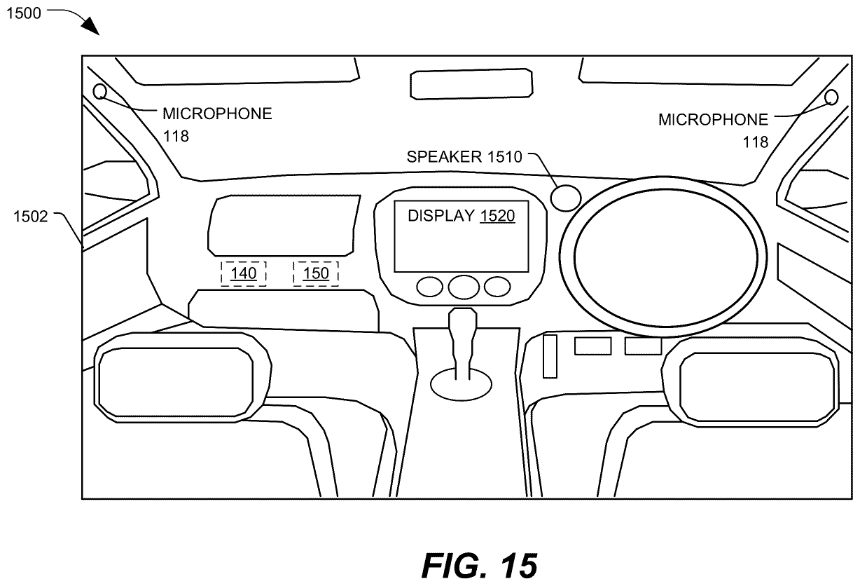

In some embodiments, the device 102 corresponds to or is included in one of various types of devices. In an illustrative example, the processor 190 is integrated in a headset device, as described further with reference to FIG. 7. In other examples, the processor 190 is integrated in at least one of a mobile phone or a tablet computer device, as described with reference to FIG. 6, a wearable electronic device, as described with reference to FIG. 8, a wireless speaker and voice activated device, as described with reference to FIG. 9, a camera device, as described with reference to FIG. 10, a mixed reality or augmented reality glasses device, as described with reference to FIG. 11, earbuds, as described with reference to FIG. 12, or a virtual reality, mixed reality, or augmented reality headset, as described with reference to FIG. 13. In another illustrative example, the processor 190 is integrated into a vehicle, such as described further with reference to FIG. 14 and FIG. 15.

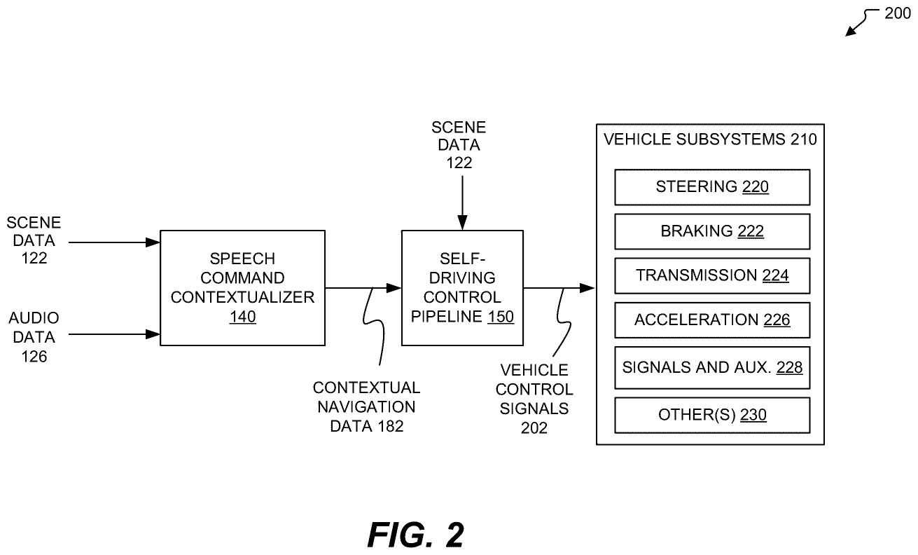

FIG. 2 illustrates an example of a system 200 that is operable to generate vehicle control signals for a vehicle based on spoken commands and a context of the vehicle. The system 200 of FIG. 2 is an example of the system 100 of FIG. 1. The system 200 includes the speech command contextualizer 140 and the self-driving control pipeline 150, each of which is configured as described above. FIG. 2 also illustrates various vehicle subsystems 210, including steering 220, braking 222, transmission 224, acceleration 226, signals and auxiliaries 228, and one or more others 230.

In some embodiments, the system 200 includes, is included within, or corresponds to the vehicle. For example, the system 200 can include a vehicle in which the device 102 and the vehicle subsystems 210 are integrated. In other embodiments, the system 200 includes features of a vehicle and features of a device (e.g., the device 102 of FIG. 1) separate from the vehicle. For example, the speech command contextualizer 140 and optionally a portion of the self-driving pipeline 150 can be integrated into a device (e.g., the device 102 of FIG. 1) that is distinct from and configured to communicate with the vehicle. In such examples, the device (e.g., the device 102) can send the contextual navigation data 182 or vehicle control signals 202 to the vehicle via a modem (e.g., the modem 170) or another communication interface (e.g., a universal serial bus interface). In some such examples, the vehicle can include one or more scene sensors (e.g., the scene sensor(s) 110) that send the scene data 122 to both the device that includes the speech command contextualizer 140 and to the portions of the self-driving control pipeline 150 that are onboard the vehicle.

Thus, the system 200 facilitates voice control of a vehicle based on context-specific, natural-language commands (e.g., speech 106 of FIG. 1), which simplifies the burden on the user of the vehicle by enabling the user to provide commands to the vehicle in much the same way the user would provide instructions to a human driver. Further, as described in more detail below, in certain embodiments, the system 200 is arranged such that all of the various machine-learning models of the speech command contextualizer 140 and optionally of the self-driving control pipeline 150 can be trained together via conventional techniques, such as backpropagation, which simplifies generation of the models and updating of the models.

FIG. 3 illustrates an example of a system 300 that is operable to generate vehicle control signals for a vehicle based on spoken commands and a context of the vehicle. The system 300 of FIG. 3 is an example of the system 100 of FIG. 1. The system 300 includes the speech command contextualizer 140, the self-driving control pipeline 150, and the vehicle subsystems 210, each of which is configured as described above.

The system 300 also includes a safety pre-processor 304. In a particular embodiment, the safety pre-processor 304 includes one or more machine-learning models (and optionally one or more procedural models) that are operable to modify one or more navigation feature embeddings 302 generated by the speech command contextualizer 140 to generate a corresponding one or more modified navigation feature embeddings 306. In particular, the safety pre-processor 304 modifies the navigation feature embedding(s) 302 to apply safety constraints. In a particular embodiment, the safety pre-processor 304 operates in an embedding space. For example, the safety pre-processor 304 can include a self-attention network decoder that is configured and trained to modify an input navigation feature embedding of the navigation feature embedding(s) 302 to generate a modified navigation feature embedding of the modified navigation feature embedding(s) 306 based on learned safety constraints. In this example, since the modifications occur in the embedding space, they can include changes to values of the navigation feature embedding (e.g., changes to one or more floating point values of a vector of values corresponding to the navigation feature embedding).

In some embodiments, the safety pre-processor 304 is configured to determine a contextual safety mask based on the navigation feature embedding(s) 302 and to apply the contextual safety mask to the navigation feature embedding(s) 302 to generate the modified navigation feature embedding(s) 306. For example, a navigation feature embedding of the navigation feature embedding(s) 302 can be provided as input to a mask generation network (e.g., a decoder of a transformer network) to generate the contextual safety mask. The contextual safety mask can be applied to the navigation feature embedding (e.g., element-by-element) to modify the navigation feature embedding to generate a modified navigation feature embedding of the modified navigation feature embedding(s) 306. In this example, the modified navigation feature embedding corresponds to the contextual navigation data 182.

The modifications applied by the safety pre-processor 304 can have various effects on the vehicle control signals 202 eventually generated by the self-driving control pipeline 150. For example, the modifications can have the effect of altering the speed of the vehicle, the timing of a turn, the time or magnitude of braking or acceleration, etc. As described further below, the safety pre-processor 304 can be trained (e.g., along with other components of the system 300, such as the speech command contextualizer 140 and/or the self-driving control pipeline 150) to apply certain safety constraints. Subsequently, the safety pre-processor 304 can be adapted, during runtime, based on feedback 308 from the self-driving control pipeline 150.

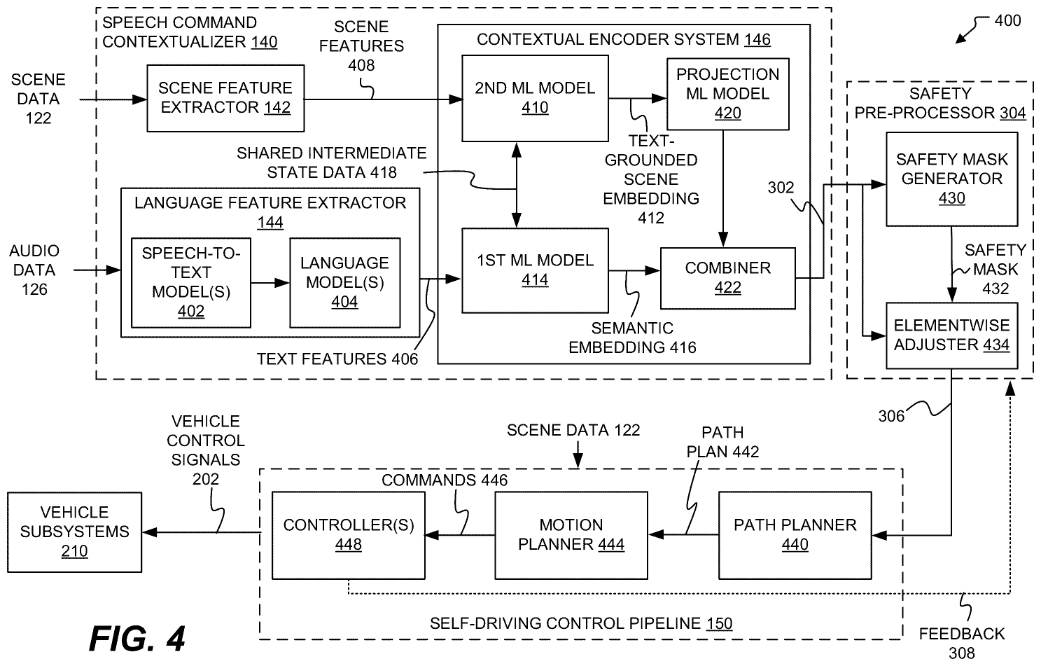

FIG. 4 illustrates an example of a system 400 that is operable to generate vehicle control signals for a vehicle based on spoken commands and a context of the vehicle. The system 400 of FIG. 4 is an example of the system 100 of FIG. 1. The system 400 includes the speech command contextualizer 140 and the self-driving control pipeline 150, each of which is configured as described above. Optionally, the system 400 also includes the safety pre-processor 304, which is configured as described with reference to FIG. 3.

In FIG. 4, the scene feature extractor 142 of the speech command contextualizer 140 is configured to generate scene features 408 representing the scene data 122. The scene data 122 includes images (e.g., 2D or 3D images) and optionally can include position data, as described with reference to FIG. 1. The scene feature extractor 142 includes one or more machine-learning models, such as one or more convolutional neural networks (CNNs), one or more self-attention networks, one or more autoencoders, or other trained models, configured to process (e.g., dimensionally reduce) image data and optionally the position data to generate scene features 408. Non-limiting examples of CNNs that can be included in the scene feature extractor 142 include a residual network (ResNet) model and a visual geometry group network (VGG) model. In addition to, or instead of, machine-learning techniques, the scene feature extractor 142 can use procedural techniques to generate the scene features 408. Non-limiting examples of procedural techniques to generate the scene features 408 include scale-invariant feature transformation (SIFT) techniques, speeded-up robust features (SURF) techniques, histogram of oriented gradients (HOG) techniques, and oriented fast and rotated brief (ORB) techniques.

In FIG. 4, the language feature extractor 144 of the speech command contextualizer 140 is configured to generate text features 406 based on speech content of the audio data 126. For example, in FIG. 4, the language feature extractor 144 includes one or more speech-to-text models 402 and one or more language models 404. The speech-to-text model(s) 402 are configured to generate text representing speech content of the audio data 126. Non-limiting examples of the speech-to-text model(s) 402 include wave-to-text models (such as ESPnet), self-attention models, hidden Markov models, and other automatic speech recognition (ASR) models as well as combinations, variants, and extensions thereof.

The language model(s) 404 are configured to process the text representing the speech content to generate the text features 406. Non-limiting examples of the language model(s) 404 include a Word2Vec model, an Embeddings from Language Model (ELMo), one or more self-attention network (such as a Bidirectional Encoder Representations from Transformers (BERT) model or a Generative Pre-trained Transformer (GPT) model), and other large language models (LLMs) as well as combinations, variants, and extensions thereof. As one illustrative example, the language model(s) 404 can include an encoder of a BERT model or another transformer model. Although FIG. 4 illustrates the language feature extractor 144 generating the text features 406 based on the speech content, in other embodiments, the language feature extractor 144 can generate linguistic features without generating text as an intermediate step. In such embodiments, the text features 406 are replaced with other linguistic features.

The contextual encoder system 146 is configured to process the scene feature data and the linguistic feature data together to generate the navigation feature embedding 302, which in FIG. 4 is an example of the contextual navigation data 182. In FIG. 4, the contextual encoder system 146 includes a first machine-learning (ML) model 414, a second ML model 410, one or more projection ML models (e.g., a projection ML model 420), and a combiner 422. In some embodiments, the first and second ML models 414, 410 are integrated, aggregated, or otherwise merged into a single model (e.g., an ensemble model).

The first ML model 414 is configured to generate a semantic embedding 416 based on data representing the speech (e.g., the linguistic feature data, such as the text features 406). In some embodiments, the semantic embedding 416 includes an object/action embedding that relates to actions specified in the speech and objects referenced in the speech. The first ML model 414 can include or correspond to a large language model, such as a transformer or other natural-language processing model. As one example, the first ML model 414 includes an encoder of a language transformer model.

The second ML model 410 is configured to generate a scene embedding (e.g., an image embedding) based on the scene features 408. The scene embedding is representative of at least visual content of the scene data 122, such as shapes, colors, patterns, and relative positions of objects represented in the scene data 122. In the example illustrated in FIG. 4, the scene embedding is a text-grounded scene embedding 412. Text grounding refers to identifying relationships between the speech content (as indicated by the text features 406) and the scene content. For example, in FIG. 4, the first ML model 414 and the second ML model 410 exchange shared intermediate state data 418 (e.g., using bi-directional self-attention masks) during processing of the scene features 408 and the text features 406. The shared intermediate state data 418 enables the second ML model 410 to generate a scene embedding (e.g., the text-grounded scene embedding 412) that is based in part on objects referenced in the speech. To illustrate, the text-grounded scene embedding 412 may include data that highlights objects referenced in the speech content. Note that because the output of the second ML model 410 is an embedding, “highlighting” in this context is not intended to imply a human discernable change; rather, it refers to generating a text-grounded image embedding that differs from an image embedding that would be generated absent the shared intermediate state data 418. As one example, the text-grounded scene embedding can include data that associates image patches of the scene data 122 with object labels for objects identified in the audio data 126. In a particular embodiment, the second ML model 410 includes or corresponds to an encoder of an image transformer model.

In some embodiments, the first ML model 414 also uses shared intermediate state data 418 from the second ML model 410 to generate the semantic embedding 416. To illustrate, the semantic embedding 416 may include data indicating actions from the audio data 126, data indicating relationships between the actions and objects represented in the scene data, or both.

The projection ML model(s) (e.g., the projection ML model 420) are configured to align the first and second embeddings to a shared feature space. In the example illustrated in FIG. 4, the projection ML model 420 is configured to map the text-grounded scene embedding 412 into the feature space of the semantic embedding 416. In other embodiments, the contextual encoder system 146 includes projection ML model(s) to map the semantic embedding 416 into the feature space of the text-grounded scene embedding 412, or to map both the text-grounded scene embedding 412 and the semantic embedding 416 to another feature space. Scene embeddings are often higher dimensional than semantic embeddings; thus, mapping the text-grounded scene embedding 412 to the feature space of the semantic embedding 416 is usually a dimensional reduction operation making the arrangement illustrated in FIG. 4 the more efficient arrangement. Non-limiting examples of the projection ML model 420 include a fully connected, feedforward neural network model, a CNN model, or another dimensional reduction model.

The combiner 422 is configured to combine embeddings in a common feature space. For example, after the projection ML model 420 projects (also referred to as aligning) the text-grounded scene embedding 412 into the feature space of the semantic embedding 416, the combiner 422 combines the projected version of the text-grounded scene embedding 412 and the semantic embedding 416. Examples of operations that can be performed by the combiner 422 to combine the embeddings include concatenation, convolution, element-wise operations, and similar techniques. In the example illustrated in FIG. 4, output of the combiner 422 corresponds to the navigation feature embedding 302.

In a particular aspect, the various components of the contextual encoder system 146 can be trained together using a training dataset that includes annotated scene data and associated textual descriptions or labels. For example, the first ML model 414 and the second ML model 410 can be trained together using contrastive learning and image-text matching techniques. In this example, image-text matching refers to the task of determining how well an image (or a portion of an image) matches particular text (e.g., a label or a textual description). To illustrate, during training, the contextual encoder system 146 or a portion thereof (e.g., the second ML model 410) can be provided, as input, training data representing images and text. An output of the contextual encoder system 146 (or the portion thereof) can be compared to the training data to determine a metric that a machine-learning training system uses to adapt weights of the contextual encoder system 146 (or the portion thereof) to improve correspondence between the output and expected output based on the training data. Contrastive learning is a training technique used to encourage the contextual encoder system 146 (or the portion thereof) to learn to distinguish between similar and dissimilar pairs among the training data. For example, for contrastive learning, the training data includes contrasting positive pairs (image-text pairs that are semantically related) and negative pairs (image-text pairs that are unrelated or have low semantic similarity) and the machine-learning training system modifies weights of the contextual encoder system 146 (or the portion thereof) to increase (e.g., maximize) a similarity metric (e.g., mutual information) associated with the positive pairs and to decrease (e.g., minimize) the similarity metric associated with the negative pairs. Techniques such as hard negative mining can be used to generate informative negative pairs.

The safety pre-processor 304 of FIG. 4 is configured to generate the modified navigation feature embedding(s) 306 based on the navigation feature embedding(s) 302. In FIG. 4, the safety pre-processor 304 includes a safety mask generator 430 and an elementwise adjuster 434. The safety mask generator 430 includes one or more machine-learning models configured to determine a safety mask 432 based on the navigation feature embedding(s) 302. For example, the safety mask generator 430 can include a decoder of a self-attention network that is configured and trained to generate the safety mask 432. The safety mask 432 is an embedding that indicates element-by-element changes to be applied to the navigation feature embedding(s) 302. The safety mask generator 430 is pre-trained to apply various safety constraints and can be updated during runtime based on the feedback 308 from the self-driving control pipeline 150.

The elementwise adjuster 434 applies the safety mask 432, element-by-element, to the navigation feature embedding(s) 302 to generate the modified navigation feature embedding(s) 306. For example, one or more values of the navigation feature embedding(s) 302 can be adjusted (e.g., increased, decreased) based on corresponding values of the safety mask 432. In another example, the safety mask 432 is a conditional embedding (e.g., each element of the safety mask 432 has a value of zero or a value of one). In this example, applying the safety mask 432 to the navigation feature embedding(s) 302 is a gating operation, where certain values of the navigation feature embedding(s) 302 pass unchanged to the modified navigation feature embedding(s) 306, and other values of the navigation feature embedding(s) 302 are zeroed out in the modified navigation feature embedding(s) 306.

In FIG. 4, the self-driving control pipeline 150 includes a path planner 440, a motion planner 444, and one or more controllers 448. In a particular aspect, the path planner 440 (also referred to as a navigation policy generator) includes one or more machine-learning models configured and trained to generate a path plan 442 based on the modified navigation feature embedding(s) 306. The path plan 442 indicates, at a relatively high level, a route for the vehicle to follow and possibly other high-level path information, such as speed, lane, etc. In some embodiments, the path planner 440 includes one or more neural networks, such as a multilayer perceptron or another feedforward network.

In a particular aspect, the motion planner 444 includes one or more machine-learning models configured and trained to generate commands 446 based on the path plan 442. The commands 446 include instructions (e.g., set points for control laws) for controller(s) 448 associated with various ones of the vehicle subsystems 210. In some embodiments, the motion planner 444 includes one or more neural networks.

The controller(s) 448 are configured to apply control laws that are associated with the vehicle subsystems 210 to generate the vehicle control signals 202. For example, a controller (e.g., one of the controller(s) 448) associated with a steering subsystem may be configured to receive a command (e.g., one of the command(s) 446) indicating a steering angle setpoint. In this example, the controller can apply proportional, integral, derivative (PID) control based on a feedback signal from a steering angle sensor to adjust the steering angle of the vehicle toward the steering angle setpoint. Although PID control is described above, the controller(s) 448 can use different types of control laws in different situations or for different vehicle subsystems 210.

The controller(s) 448 can also apply limits based on safety considerations, based on performance considerations associated with the vehicle (e.g., to improve efficiency), etc. In some embodiments, the controller(s) 448 can provide feedback 308 to the safety pre-processor 304 to enable the safety pre-processor 304 to be updated during use. For example, a steering control law associated with the steering angle may limit the rate at which the steering angle can be changed depending on the speed of the vehicle. As a result, the actual path followed by the vehicle may deviate from the path plan 442. In this example, updating the safety pre-processor 304 based on a feedback signal (e.g., the feedback 308) from the steering control law enables the safety pre-processor 304 to generate the modified navigation feature embedding(s) 306 in a manner that accounts for the steering angle/speed relationship so that the path planner 440 generates the path plan 442 to account for such limitations before the command(s) 446 are generated, which means that the path plan 442 more closely aligns with the actual vehicle performance capabilities, constraints, etc.

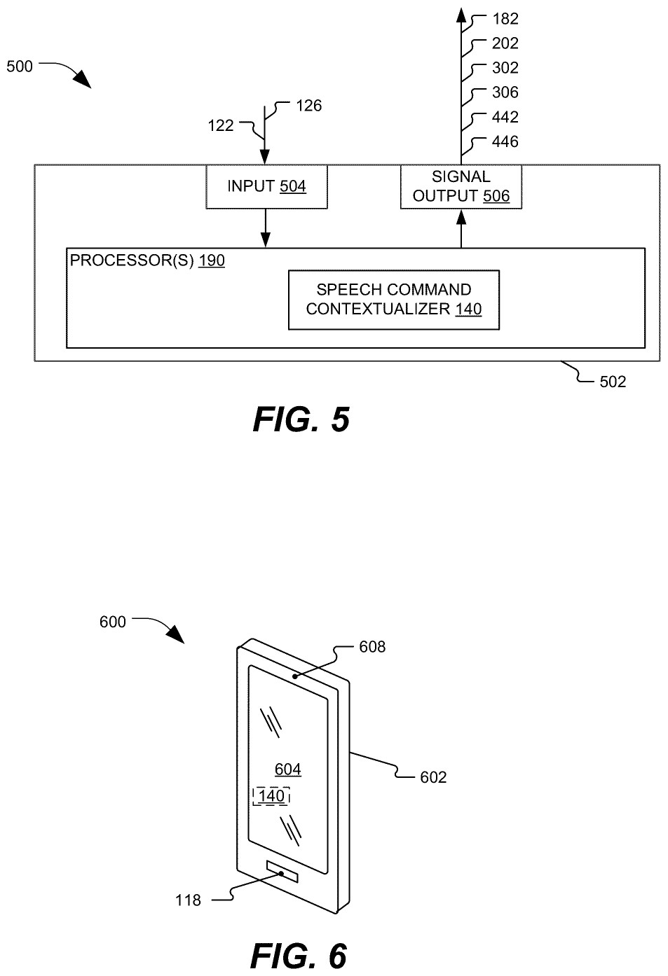

FIG. 5 depicts an embodiment 500 of the device 102 as an integrated circuit 502 that includes the one or more processors 190. The integrated circuit 502 also includes an input 504, such as one or more bus interfaces, to enable the audio data 126 and the scene data 122 to be received for processing. The integrated circuit 502 also includes a signal output 506, such as a bus interface, to enable sending of an output signal, such as the contextual navigation data 182, the vehicle control signals 202, the navigation feature embedding(s) 302, the modified navigation feature embedding(s) 306, the path plan 442, the commands 446, or a combination thereof.

The integrated circuit 502 includes the speech command contextualizer 140, which enables implementation of speech-based vehicle control as a component in a system, such as a mobile phone or tablet device as depicted in FIG. 6, a headset device as depicted in FIG. 7, a wearable electronic device as depicted in FIG. 8, a wireless speaker and voice activated device as depicted in FIG. 9, a camera device as depicted in FIG. 10, a mixed reality or augmented reality glasses device as depicted in FIG. 11, earbuds as depicted in FIG. 12, a virtual reality, mixed reality, or augmented reality headset as depicted in FIG. 13, or a vehicle as depicted in FIG. 14 or FIG. 15.

FIG. 6 depicts an embodiment 600 in which the device 102 includes a mobile device 602, such as a phone or tablet, as illustrative, non-limiting examples. The mobile device 602 includes the microphone(s) 118, one or more speakers 608, and a display screen 604. Components of the processor 190, including at least a portion of the speech command contextualizer 140, are integrated in the mobile device 602 and are illustrated using dashed lines to indicate internal components that are not generally visible to a user of the mobile device 602.

In the example illustrated in FIG. 6, the speech command contextualizer 140 is operable to obtain audio data (e.g., the audio data 126) representing sound captured by the microphone(s) 118 and to process speech content of the audio data along with scene data associated with an operating environment of a vehicle to enable generation of vehicle control signal(s) for the vehicle. In some embodiments, only a first portion of the speech command contextualizer 140 resides onboard the mobile device 602, and a second portion of the speech command contextualizer 140 resides at another device. For example, the language feature extractor 144 of the speech command contextualizer 140 can reside onboard the mobile device 602, and the scene feature extractor 142 and the contextual encoder system 146 can reside onboard the vehicle. Disposing at least a portion of the speech command contextualizer 140 onboard the mobile device 602 enables the mobile device 602 to assist with processing of context-specific, natural-language speech commands for control of the vehicle, which enables voice-guided navigation and vehicle control in a natural and intuitive way and reduces the need for manual input via complex interfaces. This simplified and improved method of user interaction enables use by a wider range of users.

Often, mobile devices, such as the mobile device 602, are associated with a single user or a small group of users. Accordingly, including at least the language feature extractor 144 onboard the mobile device 602 may enable customization (e.g., fine-tuning) of the language feature extractor 144 to better understand particular user(s) and thereby to generate more accurate representations of speech of such user(s). Additionally, many such mobile devices 602 include a variety of sensors that are able to capture relevant portions of the scene data 122, such as position sensors, cameras, etc.

Further, including a portion of the speech command contextualizer 140 onboard the mobile device 602 and a second portion of the speech command contextualizer 140 onboard the vehicle enables local control or remote control of the vehicle using spoken commands. To illustrate, the mobile device 602 can be with a passenger of the vehicle, and the passenger can provide speech input (e.g., “turn into the second driveway on the left”) via the mobile device 602 to control operation of the vehicle. Alternatively, the user can remotely control the vehicle using the mobile device 602 (e.g., by providing a voice instruction such as “come pick me up in front of the convenience store”). In any of these examples, the scene around the vehicle can be used to interpret the speech content and to safely operate the vehicle. Additionally, at least some of the scene data 122 can be output via the display screen 604 to assist the user with providing relevant speech commands.

FIG. 7 depicts an embodiment 700 in which the device 102 includes a headset device 702. The headset device 702 includes the microphone(s) 118 and one or more speakers 708. Components of the processor 190, including at least a portion of the speech command contextualizer 140, are integrated in the headset device 702.

In the example illustrated in FIG. 7, the speech command contextualizer 140 is operable to obtain audio data (e.g., the audio data 126) representing sound captured by the microphone(s) 118 and process speech content of the audio data along with scene data associated with an operating environment of a vehicle to enable generation of vehicle control signal(s) for the vehicle. In some embodiments, only a first portion of the speech command contextualizer 140 resides onboard the headset device 702, and a second portion of the speech command contextualizer 140 resides at another device. For example, the language feature extractor 144 of the speech command contextualizer 140 can reside onboard the headset device 702, and the scene feature extractor 142 and the contextual encoder system 146 can reside onboard the vehicle. Disposing at least a portion of the speech command contextualizer 140 onboard the headset device 702 enables the headset device 702 to assist with processing of context-specific, natural-language speech commands for control of the vehicle, which enables voice-guided navigation and vehicle control in a natural and intuitive way and reduces the need for manual input via complex interfaces. This simplified and improved method of user interaction enables use by a wider range of users.

Often, headset devices, such as the headset device 702, are associated with a single user or a small group of users. Accordingly, including at least the language feature extractor 144 onboard the headset device 702 may enable customization (e.g., fine-tuning) of the language feature extractor 144 to better understand particular user(s) and thereby to generate more accurate representations of speech of such user(s). Further, including a portion of the speech command contextualizer 140 onboard the headset device 702 and a second portion of the speech command contextualizer 140 onboard the vehicle enables local control or remote control of the vehicle using spoken commands.

FIG. 8 depicts an embodiment 800 in which the device 102 includes a wearable electronic device 802, illustrated as a “smart watch.” The wearable electronic device 802 includes a display screen 804, the microphone(s) 118, and one or more speakers 806. Components of the processor 190, including at least a portion of the speech command contextualizer 140, are integrated in the wearable electronic device 802.

In the example illustrated in FIG. 8, the speech command contextualizer 140 is operable to obtain audio data (e.g., the audio data 126) representing sound captured by the microphone(s) 118 and process speech content of the audio data along with scene data associated with an operating environment of a vehicle to enable generation of vehicle control signal(s) for the vehicle. In some embodiments, only a first portion of the speech command contextualizer 140 resides onboard the wearable electronic device 802, and a second portion of the speech command contextualizer 140 resides at another device. For example, the language feature extractor 144 of the speech command contextualizer 140 can reside onboard the wearable electronic device 802, and the scene feature extractor 142 and the contextual encoder system 146 can reside onboard the vehicle. Disposing at least a portion of the speech command contextualizer 140 onboard the wearable electronic device 802 enables the wearable electronic device 802 to assist with processing of context-specific, natural-language speech commands for control of the vehicle, which enables voice-guided navigation and vehicle control in a natural and intuitive way and reduces the need for manual input via complex interfaces. This simplified and improved method of user interaction enables use by a wider range of users.

Often, wearable electronic devices, such as the wearable electronic device 802, are associated with a single user or a small group of users. Accordingly, including at least the language feature extractor 144 onboard the wearable electronic device 802 may enable customization (e.g., fine-tuning) of the language feature extractor 144 to better understand particular user(s) and thereby to generate more accurate representations of speech of such user(s).

Further, including a portion of the speech command contextualizer 140 onboard the wearable electronic device 802 and a second portion of the speech command contextualizer 140 onboard the vehicle enables local control or remote control of the vehicle using spoken commands. Additionally, at least some of the scene data 122 used to control the vehicle can be output via the display screen 804 to assist the user with providing relevant speech commands.

FIG. 9 is an embodiment 900 in which the device 102 includes a wireless speaker and voice activated device 902. The wireless speaker and voice activated device 902 can have wireless network connectivity and is configured to execute an assistant operation. The wireless speaker and voice activated device 902 includes the microphone(s) 118 and one or more speakers 906. Optionally, in some embodiments, the wireless speaker and voice activated device 902 includes a display 904. Components of the processor 190, including at least a portion of the speech command contextualizer 140, are integrated in the wireless speaker and voice activated device 902.

In the example illustrated in FIG. 9, the speech command contextualizer 140 is operable to obtain audio data (e.g., the audio data 126) representing sound captured by the microphone(s) 118 and process speech content of the audio data along with scene data associated with an operating environment of a vehicle to enable generation of vehicle control signal(s) for the vehicle. In some embodiments, only a first portion of the speech command contextualizer 140 resides onboard the wireless speaker and voice activated device 902, and a second portion of the speech command contextualizer 140 resides at another device. For example, the language feature extractor 144 of the speech command contextualizer 140 can reside onboard the wireless speaker and voice activated device 902, and the scene feature extractor 142 and the contextual encoder system 146 can reside onboard the vehicle. Disposing at least a portion of the speech command contextualizer 140 onboard the wireless speaker and voice activated device 902 enables the wireless speaker and voice activated device 902 to assist with processing of context-specific, natural-language speech commands for control of the vehicle, which enables voice-guided navigation and vehicle control in a natural and intuitive way and reduces the need for manual input via complex interfaces. This simplified and improved method of user interaction enables use by a wider range of users. Additionally, at least some of the scene data 122 can be output via the display 904 to assist the user with providing relevant speech commands.

FIG. 10 depicts an embodiment 1000 in which the device 102 includes a portable electronic device that corresponds to a camera device 1002. The camera device 1002 includes the microphones 118, an image sensor 1004, and one or more speakers 1008. Components of the processor 190, including at least a portion of the speech command contextualizer 140, are integrated in the camera device 1002.

In the example illustrated in FIG. 10, the speech command contextualizer 140 is operable to obtain audio data (e.g., the audio data 126) representing sound captured by the microphone(s) 118 and process speech content of the audio data along with scene data associated with an operating environment of a vehicle to enable generation of vehicle control signal(s) for the vehicle. In some embodiments, only a first portion of the speech command contextualizer 140 resides onboard the camera device 1002, and a second portion of the speech command contextualizer 140 resides at another device. For example, the language feature extractor 144 of the speech command contextualizer 140 can reside onboard the camera device 1002, and the scene feature extractor 142 and the contextual encoder system 146 can reside onboard the vehicle.

As another example, the scene feature extractor 142 and the language feature extractor 144 can reside onboard the camera device 1002, and the contextual encoder system 146 can reside onboard the vehicle. In this example, the scene data 122 includes images captured by the image sensor 1004 of the camera device 1002. Disposing at least a portion of the speech command contextualizer 140 onboard the camera device 1002 enables the camera device 1002 to assist with processing of context-specific, natural-language speech commands for control of the vehicle, which enables voice-guided navigation and vehicle control in a natural and intuitive way and reduces the need for manual input via complex interfaces.

FIG. 11 depicts an embodiment 1100 in which the device 102 includes a portable electronic device that corresponds to augmented reality or mixed reality glasses 1102. The glasses 1102 include a holographic projection unit 1104 configured to project visual data onto a surface of a lens 1106 or to reflect the visual data off of a surface of the lens 1106 and onto the wearer's retina. The glasses 1102 also include the microphones 118 and one or more speakers 1108. Components of the processor 190, including at least a portion of the speech command contextualizer 140, are integrated in the glasses 1102.

In the example illustrated in FIG. 11, the speech command contextualizer 140 is operable to obtain audio data (e.g., the audio data 126) representing sound captured by the microphone(s) 118 and process speech content of the audio data along with scene data associated with an operating environment of a vehicle to enable generation of vehicle control signal(s) for the vehicle. In some embodiments, only a first portion of the speech command contextualizer 140 resides onboard the glasses 1102, and a second portion of the speech command contextualizer 140 resides at another device. For example, the language feature extractor 144 of the speech command contextualizer 140 can reside onboard the glasses 1102, and the scene feature extractor 142 and the contextual encoder system 146 can reside onboard the vehicle. Additionally, at least some of the scene data 122 used to control the vehicle can be output as images projected onto the lenses 1106 to assist the user with providing relevant speech commands. Disposing at least a portion of the speech command contextualizer 140 onboard the glasses 1102 enables the glasses 1102 to assist with processing of context-specific, natural-language speech commands for control of the vehicle, which enables voice-guided navigation and vehicle control in a natural and intuitive way and reduces the need for manual input via complex interfaces. This simplified and improved method of user interaction enables use by a wider range of users.

FIG. 12 depicts an embodiment 1200 in which the device 102 includes a portable electronic device that corresponds to a pair of earbuds 1206 that includes a first earbud 1202 and a second earbud 1204. Although earbuds are described, it should be understood that the present technology can be applied to other in-ear or over-ear audio devices, such as a hearing aid device.

The first earbud 1202 includes a first microphone 1220, such as a high signal-to-noise microphone positioned to capture the voice of a wearer of the first earbud 1202, an array of one or more other microphones configured to detect ambient sounds and spatially distributed to support beamforming, illustrated as microphones 1222A, 1222B, and 1222C, an “inner” microphone 1224 proximate to the wearer's ear canal (e.g., to assist with active noise cancelling), and a self-speech microphone 1226, such as a bone conduction microphone configured to convert sound vibrations of the wearer's ear bone or skull into an audio signal. The microphone(s) 118 of FIG. 1 can correspond to or include any combination of the microphones 1220, 1222, 1224, 1226 of FIG. 12.

The second earbud 1204 can be configured in a substantially similar manner as the first earbud 1202. In some embodiments, the first earbud 1202 is also configured to receive one or more audio signals generated by one or more microphones of the second earbud 1204, such as via wireless transmission between the earbuds 1202, 1204, or via wired transmission in embodiments in which the earbuds 1202, 1204 are coupled via a transmission line.

In some embodiments, the earbuds 1202, 1204 are configured to automatically switch between various operating modes, such as a passthrough mode in which ambient sound is played via a speaker 1230, a playback mode in which non-ambient sound (e.g., streaming audio corresponding to a phone conversation, media playback, video game, etc.) is played back through the speaker 1230, and an audio zoom mode or beamforming mode in which one or more ambient sounds are emphasized and/or other ambient sounds are suppressed for playback at the speaker 1230. In other embodiments, the earbuds 1202, 1204 may support fewer modes or may support one or more other modes in place of, or in addition to, the described modes.

In an illustrative example, the earbuds 1202, 1204 can automatically transition from the playback mode to the passthrough mode in response to detecting the wearer's voice and may automatically transition back to the playback mode after the wearer has ceased speaking. In some examples, the earbuds 1202, 1204 can operate in two or more of the modes concurrently, such as by performing audio zoom on a particular ambient sound (e.g., a dog barking) and playing out the audio zoomed sound superimposed on the sound being played out while the wearer is listening to music (which can be reduced in volume while the audio zoomed sound is being played). In this example, the wearer can be alerted to the ambient sound associated with the audio event without halting playback of the music.

In FIG. 12, components of the processor 190, including at least a portion of the speech command contextualizer 140, are integrated in the earbuds 1202, 1204 (e.g., in the earbud 1202, in the earbud 1204, or in both). In the example illustrated in FIG. 12, the speech command contextualizer 140 is operable to obtain audio data (e.g., the audio data 126) representing sound captured by one or more of the microphones 1220, 1222, 1224, 1226 and process speech content of the audio data along with scene data associated with an operating environment of a vehicle to enable generation of vehicle control signal(s) for the vehicle. In some embodiments, only a first portion of the speech command contextualizer 140 resides onboard the earbuds 1202, 1204, and a second portion of the speech command contextualizer 140 resides at another device. For example, the language feature extractor 144 of the speech command contextualizer 140 can reside onboard the earbuds 1202, 1204, and the scene feature extractor 142 and the contextual encoder system 146 can reside onboard the vehicle. Disposing at least a portion of the speech command contextualizer 140 onboard the earbuds 1202, 1204 enables the earbuds 1202, 1204 to assist with processing of context-specific, natural-language speech commands for control of the vehicle, which enables voice-guided navigation and vehicle control in a natural and intuitive way and reduces the need for manual input via complex interfaces. This simplified and improved method of user interaction enables use by a wider range of users.

FIG. 13 depicts an embodiment 1300 in which the device 102 includes a portable electronic device that corresponds to a virtual reality, mixed reality, or augmented reality headset 1302. A visual interface device 1306 is positioned in front of the user's eyes to enable display of augmented reality, mixed reality, or virtual reality images or scenes to the user while the headset 1302 is worn. The headset 1302 also includes the microphones 118 and one or more speakers 1304. Components of the processor 190, including at least a portion of the speech command contextualizer 140, are integrated in the headset 1302.

In the example illustrated in FIG. 13, the speech command contextualizer 140 is operable to obtain audio data (e.g., the audio data 126) representing sound captured by the microphone(s) 118 and process speech content of the audio data along with scene data associated with an operating environment of a vehicle to enable generation of vehicle control signal(s) for the vehicle. In some embodiments, only a first portion of the speech command contextualizer 140 resides onboard the headset 1302, and a second portion of the speech command contextualizer 140 resides at another device. For example, the language feature extractor 144 of the speech command contextualizer 140 can reside onboard the headset 1302, and the scene feature extractor 142 and the contextual encoder system 146 can reside onboard the vehicle. Disposing at least a portion of the speech command contextualizer 140 onboard the headset 1302 enables the headset 1302 to assist with processing of context-specific, natural-language speech commands for control of the vehicle, which enables voice-guided navigation and vehicle control in a natural and intuitive way and reduces the need for manual input via complex interfaces. This simplified and improved method of user interaction enables use by a wider range of users.

FIG. 14 depicts an embodiment 1400 in which the device 102 corresponds to, or is integrated within, a vehicle 1402, illustrated as a manned or unmanned aerial device (e.g., a package delivery drone). The vehicle 1402 includes the microphones 118, and one or more speakers 1404. Components of the processor 190, including at least a portion of the speech command contextualizer 140 and the self-driving control pipeline 150, are integrated in the vehicle 1402.

In the example illustrated in FIG. 14, the speech command contextualizer 140 is operable to obtain audio data (e.g., the audio data 126) representing sound captured by the microphone(s) 118 and process speech content of the audio data along with scene data associated with an operating environment of the vehicle 1402 to enable the self-driving control pipeline 150 to generate vehicle control signal(s) for the vehicle 1402. In some embodiments, only a first portion of the speech command contextualizer 140 resides onboard the vehicle 1402, and a second portion of the speech command contextualizer 140 resides at another device. For example, the language feature extractor 144 of the speech command contextualizer 140 can reside on a remote device (such as, without limitation, the mobile device 602, the headset device 702, the wearable electronic device 802, the wireless speaker and voice activated device 902, the camera device 1002, the glasses 1102, the earbuds 1202, 1204, or the headset 1302), and the scene feature extractor 142 and the contextual encoder system 146 can reside onboard the vehicle 1402. Disposing at least a portion of the speech command contextualizer 140 onboard the vehicle 1402 enables the vehicle 1402 to assist with processing of context-specific, natural-language speech commands for control of the vehicle 1402, which enables voice-guided navigation and vehicle control in a natural and intuitive way and reduces the need for manual input via complex interfaces. This simplified and improved method of user interaction enables use by a wider range of users.

FIG. 15 depicts another embodiment 1500 in which the device 102 corresponds to, or is integrated within, a vehicle 1502, illustrated as a car. The vehicle 1502 includes a display screen 1520, the microphones 118, and one or more speakers 1510.

Components of the processor 190, including at least a portion of the speech command contextualizer 140 and the self-driving control pipeline 150, are integrated in the vehicle 1502.

In the example illustrated in FIG. 15, the speech command contextualizer 140 is operable to obtain audio data (e.g., the audio data 126) representing sound captured by the microphone(s) 118 and process speech content of the audio data along with scene data associated with an operating environment of the vehicle 1502 to enable the self-driving control pipeline 150 to generate vehicle control signal(s) for the vehicle 1502. In some embodiments, only a first portion of the speech command contextualizer 140 resides onboard the vehicle 1502, and a second portion of the speech command contextualizer 140 resides at another device. For example, the language feature extractor 144 of the speech command contextualizer 140 can reside on a remote device (such as, without limitation, the mobile device 602, the headset device 702, the wearable electronic device 802, the wireless speaker and voice activated device 902, the camera device 1002, the glasses 1102, the earbuds 1202, 1204, or the headset 1302), and the scene feature extractor 142 and the contextual encoder system 146 can reside onboard the vehicle 1502. Disposing at least a portion of the speech command contextualizer 140 onboard the vehicle 1502 enables the vehicle 1502 to assist with processing of context-specific, natural-language speech commands for control of the vehicle 1502, which enables voice-guided navigation and vehicle control in a natural and intuitive way and reduces the need for manual input via complex interfaces. This simplified and improved method of user interaction enables use by a wider range of users.

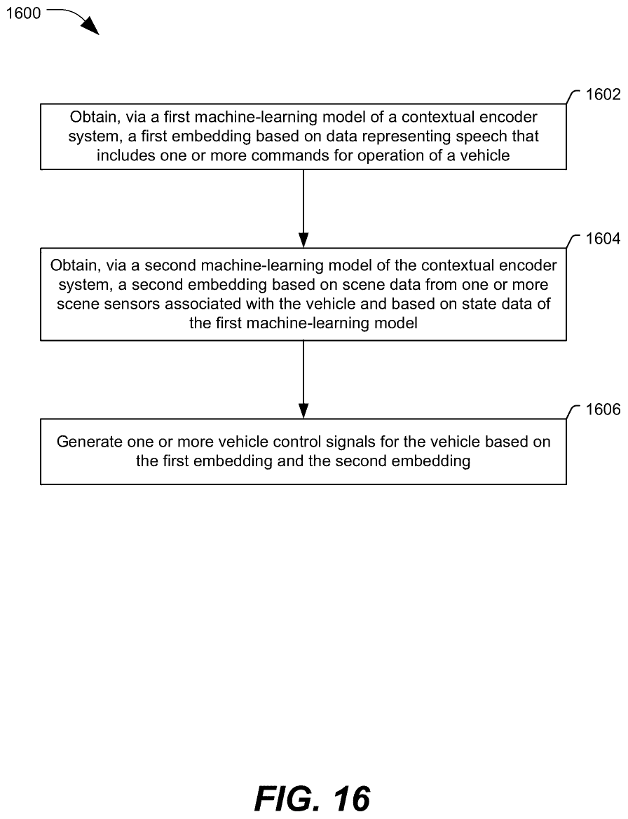

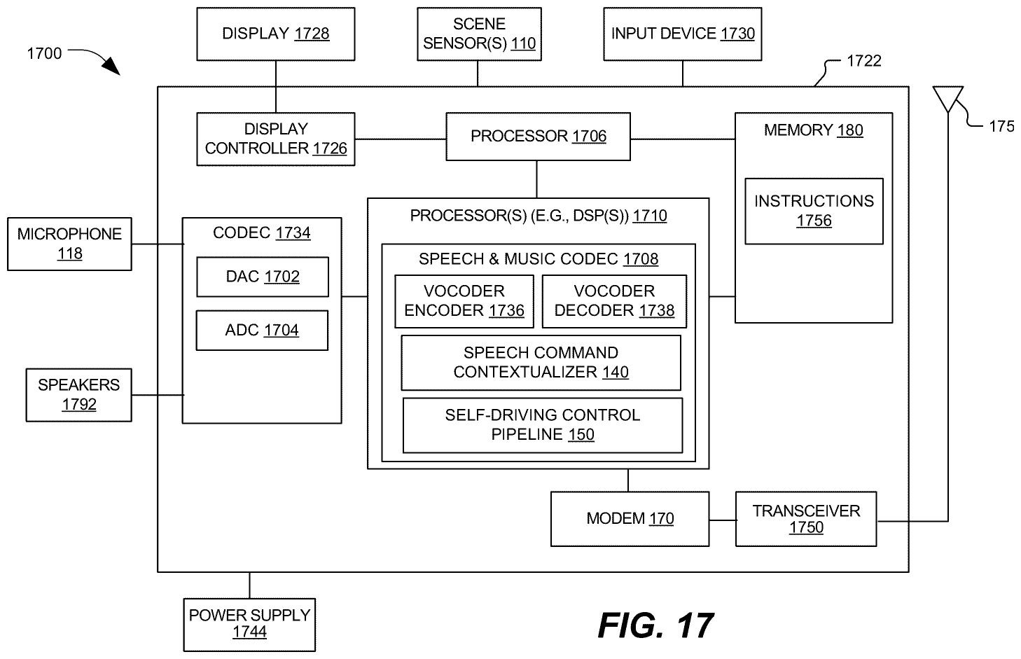

Referring to FIG. 16, a particular embodiment of a method 1600 of controlling a vehicle based on speech commands is shown. In a particular aspect, one or more operations of the method 1600 are performed by at least one of the speech command contextualizer 140, the processor 190, the device 102, the system 100 of FIG. 1, or a combination thereof.

In some embodiments, the method 1600 includes, at block 1602, obtaining, via a first machine-learning model of a contextual encoder system, a first embedding based on data representing speech that includes one or more commands for operation of a vehicle. In an example, audio data (at least a portion of which represents speech) can be captured by one or more microphones associated with the vehicle. In this example, text representing the speech can be obtained from one or more speech-to-text models, and text feature data based on the text can be obtained from one or more language models. The text feature data can be provided as input to the first machine-learning model to generate the first embedding.

In a particular embodiment, the first machine-learning model includes or corresponds to the first machine-learning model 414 of FIG. 4. In this embodiment, the first machine-learning model 414 is configured to receive as input the text features 406, which represent speech present in the audio data 126. The speech can include one or more commands for control of the vehicle, such as a natural-language command that relates an action to be performed to a feature of a local context in which the vehicle is operating. Further, in this embodiment, the first machine-learning model 414 generates as output the semantic embedding 416 (e.g., a first embedding), which is based on the speech.

The method 1600 also includes, at block 1604, obtaining, via a second machine-learning model of the contextual encoder system, a second embedding based on scene data from one or more scene sensors associated with the vehicle and based on state data of the first machine-learning model. For example, the second machine-learning model can include or correspond to the second machine-learning model 410 of FIG. 4. In this example, the second machine-learning model 410 is configured to receive as input the scene features 408 and the shared intermediate state data 418. The scene features 408 are based on the scene data 122 from the scene sensor(s) 110 of FIG. 1. Further, in this example, the second machine-learning model 410 generates as output the text-grounded scene embedding 412 (e.g., a second embedding), which is based on the scene features 408 and the shared intermediate state data 418.

In a particular embodiment, the contextual encoder system includes the first machine-learning model interconnected with the second machine-learning model for two-way exchange of shared intermediate state data. In this embodiment, the shared intermediate state data includes the state data of the first machine-learning model which is shared with the second machine-learning model during generation of the second embedding and second state data of the second machine-learning model which is shared with the first machine-learning model during generation of the first embedding.

The method 1600 also includes, at block 1606, generating one or more vehicle control signals for the vehicle based on the first embedding and the second embedding. For example, the system 400 of FIG. 4 is configured to generate the vehicle control signals 202 based on the semantic embedding 416 (e.g., the first embedding) and the text-grounded scene embedding 412 (e.g., the second embedding).

In some embodiments, generating the vehicle control signal(s) based on the first embedding and the second embedding includes a plurality of operations. For example, in some embodiments, generating the vehicle control signal(s) based on the first embedding and the second embedding includes using one or more projection models (e.g., the projection machine-learning model 420 of FIG. 4) to align the first and second embeddings to a shared feature space and combining the aligned first and second embeddings to form a navigation feature embedding (e.g., the navigation feature embedding 302), where the vehicle control signals 202 are based on the navigation feature embedding 302. In some such embodiments, the navigation feature embedding can be used to generate a contextual safety mask, which can be applied to the navigation feature embedding to generate a masked navigation feature embedding (e.g., the modified navigation feature embedding(s) 306) that is based on the navigation feature embedding and the contextual safety mask. In such embodiments, the one or more vehicle control signals are based on the masked navigation feature embedding.

In some embodiments, the method 1600 can include determining a path plan for the vehicle based on the first embedding and the second embedding, where the one or more vehicle control signals are based on the path plan. For example, the path planner 440 of FIG. 4 can generate the path plan 442 based on the modified navigation feature embedding(s) 306, which as described above, is generated based on the first and second embeddings.

The method 1600 can also include obtaining commands for one or more controllers of the vehicle based on the first embedding and the second embedding, where the one or more controllers are configured to apply control laws to determine the vehicle control signals based on the commands. For example, the path plan 442 can be provided as input to the motion planner 444 of FIG. 4 to generate the commands 446 provided to the controller(s) 448. In this example, the controller(s) 448 applies control laws (as well as at least a portion of the scene data 122) to generate the vehicle control signals 202.

The method 1600 of FIG. 16 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1600 of FIG. 16 may be performed by a processor that executes instructions, such as described with reference to FIG. 17.

Referring to FIG. 17, a block diagram of a particular illustrative embodiment of a device is depicted and generally designated 1700. In various embodiments, the device 1700 may have more or fewer components than illustrated in FIG. 17. In an illustrative embodiment, the device 1700 may correspond to the device 102. In an illustrative embodiment, the device 1700 may perform one or more operations described with reference to FIGS. 1-16.

In a particular embodiment, the device 1700 includes a processor 1706 (e.g., a CPU). The device 1700 may include one or more additional processors 1710 (e.g., one or more DSPs). In a particular aspect, the processor 190 of FIG. 1 corresponds to the processor 1706, the processors 1710, or a combination thereof. The processors 1710 may include a speech and music coder-decoder (CODEC) 1708 that includes a voice coder (“vocoder”) encoder 1736, a vocoder decoder 1738, the speech command contextualizer 140, or a combination thereof. Optionally, the processor(s) 1710 can include the self-driving control pipeline 150. In some embodiments, the processor(s) 1710 include only a portion of the speech command contextualizer 140, such as only one of the scene feature extractor 142 or the language feature extractor 144. In some embodiments, the processor(s) 1710 also include the contextual encoder system 146.

In this context, the term “processor” refers to an integrated circuit including logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations of a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnected sets of transistors and memory elements) that can be configured (often on the fly) to perform customizable logic functions.

The device 1700 may include the memory 180 and a CODEC 1734. The memory 180 may include instructions 1756, that are executable by the one or more additional processors 1710 (or the processor 1706) to implement the functionality described with reference to at least a portion of the speech command contextualizer 140, the self-driving control pipeline 150, or both. The device 1700 may include the modem 170 coupled, via a transceiver 1750, to an antenna 1752.

The device 1700 may include a display 1728 coupled to a display controller 1726. One or more speakers 1792 and the microphone(s) 118 may be coupled to the CODEC 1734. The CODEC 1734 may include a digital-to-analog converter (DAC) 1702, an analog-to-digital converter (ADC) 1704, or both. In a particular embodiment, the CODEC 1734 may receive analog signals from the microphone(s) 118, convert the analog signals to digital signals using the analog-to-digital converter 1704, and provide the digital signals to the speech and music codec 1708. The speech and music codec 1708 may process the digital signals, and the digital signals may further be processed by the speech command contextualizer 140, such as to generate vehicle control signals based on speech content of the digital signals. In a particular embodiment, the speech and music codec 1708 may provide digital signals to the CODEC 1734. The CODEC 1734 may convert the digital signals to analog signals using the digital-to-analog converter 1702 and may provide the analog signals to the speaker 1792.

In a particular embodiment, the device 1700 may be included in a system-in-package or system-on-chip device 1722. In a particular embodiment, the memory 180, the processor 1706, the processors 1710, the display controller 1726, the CODEC 1734, the transceiver 1750, and the modem 170 are included in the system-in-package or system-on-chip device 1722. In a particular embodiment, the scene sensors 110, an input device 1730, and a power supply 1744 are coupled to the system-in-package or the system-on-chip device 1722. Moreover, in a particular embodiment, as illustrated in FIG. 17, the display 1728, the scene sensors 110, the input device 1730, the speaker(s) 1792, the microphone(s) 118, the antenna 1752, and the power supply 1744 are external to the system-in-package or the system-on-chip device 1722. In a particular embodiment, each of the display 1728, the scene sensors 110, the input device 1730, the speaker(s) 1792, the microphone(s) 118, the antenna 1752, and the power supply 1744 may be coupled to a component of the system-in-package or the system-on-chip device 1722, such as an interface or a controller.

The device 1700 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In some embodiments, a non-transitory computer-readable medium (e.g., a computer-readable storage device, such as the memory 180) includes instructions (e.g., the instructions 1756) that, when executed by one or more processors (e.g., the processor(s) 190 of FIG. 1, the processor(s) 1710, or the processor 1706), cause the one or more processors to obtain, via a first machine-learning model of a contextual encoder system, a first embedding based on data representing speech that includes one or more commands for operation of a vehicle; obtain, via a second machine-learning model of the contextual encoder system, a second embedding based on scene data from one or more scene sensors associated with the vehicle and based on state data of the first machine-learning model; and generate one or more vehicle control signals for the vehicle based on the first embedding and the second embedding.

In conjunction with the described embodiments, an apparatus includes means for obtaining, via a first machine-learning model of a contextual encoder system, a first embedding based on data representing speech that includes one or more commands for operation of a vehicle. For example, the means for obtaining the first embedding based on the data representing the speech can include the device 102, the processor(s) 190, the speech command contextualizer 140, the contextual encoder system 146, the first ML model 414, the integrated circuit 502, the processor 1706, the processor(s) 1710, the system-in-package or the system-on-chip device 1722, the device 1700, other circuitry configured to obtain a first embedding based on data representing speech that includes one or more commands for operation of a vehicle, or a combination thereof.

The apparatus also includes means for obtaining, via a second machine-learning model of the contextual encoder system, a second embedding based on scene data from one or more scene sensors associated with the vehicle and based on state data of the first machine-learning model. For example, the means for obtaining the second embedding based on scene data and the state data can include the device 102, the processor(s) 190, the speech command contextualizer 140, the contextual encoder system 146, the second ML model 410, the integrated circuit 502, the processor 1706, the processor(s) 1710, the system-in-package or the system-on-chip device 1722, the device 1700, other circuitry configured to obtain a second embedding based on scene data and state data, or a combination thereof.

The apparatus also includes means for generating one or more vehicle control signals for the vehicle based on the first embedding and the second embedding. For example, the means for generating one or more vehicle control signals for the vehicle based on the first embedding and the second embedding can include the device 102, the processor(s) 190, the speech command contextualizer 140, the contextual encoder system 146, the self-driving control pipeline 150, the safety pre-processor 304, the integrated circuit 502, the processor 1706, the processor(s) 1710, other circuitry configured to generate one or more vehicle control signals for a vehicle based on first and second embeddings, or a combination thereof.

Particular aspects of the disclosure are described below in sets of interrelated Examples:

According to Example 1, a device includes memory configured to store scene data from one or more scene sensors associated with a vehicle; and one or more processors configured to obtain, via a first machine-learning model of a contextual encoder system, a first embedding based on data representing speech that includes one or more commands for operation of the vehicle; obtain, via a second machine-learning model of the contextual encoder system, a second embedding based on the scene data and based on state data of the first machine-learning model; and generate one or more vehicle control signals for the vehicle based on the first embedding and the second embedding.

Example 2 includes the device of Example 1, wherein at least one command of the one or more commands relates an action to be performed to a feature of a local context in which the vehicle is operating.

Example 3 includes the device of Example 1 or Example 2, wherein the first embedding corresponds to a semantic embedding and the second embedding corresponds to a text-grounded scene embedding.

Example 4 includes the device of any of Examples 1 to 3, wherein the one or more processors are configured to generate a navigation feature embedding based on the first embedding and the second embedding, and wherein the one or more vehicle control signals are based on the navigation feature embedding.

Example 5 includes the device of Example 4, wherein, to generate the navigation feature embedding, the one or more processors are configured to use one or more projection models to align the first and second embeddings to a shared space; and combine the aligned first and second embeddings to form the navigation feature embedding.

Example 6 includes the device of Example 5, wherein the one or more projection models include feedforward fully connected networks configured to modify dimensionality of the first embedding, the second embedding, or both.

Example 7 includes the device of any of Examples 4 to 6, wherein the one or more processors are configured to generate a masked navigation feature embedding based on the navigation feature embedding and a contextual safety mask, and wherein the one or more vehicle control signals are based on the masked navigation feature embedding.

Example 8 includes the device of Example 7, wherein the one or more processors are configured to generate, based on the first embedding and the second embedding, the contextual safety mask using a decoder of a transformer network.

Example 9 includes the device of any of Examples 1 to 8, wherein the one or more processors are configured to determine a path plan for the vehicle based on the first embedding and the second embedding, and wherein the one or more vehicle control signals are based on the path plan.

Example 10 includes the device of any of Examples 1 to 9, wherein the one or more processors are configured to obtain commands for one or more controllers of the vehicle based on the first embedding and the second embedding, and wherein the one or more controllers are configured to apply control laws to determine the vehicle control signals based on the commands.

Example 11 includes the device of any of Examples 1 to 10, wherein the one or more processors are configured to obtain audio data captured by one or more microphones associated with the vehicle, wherein at least a portion of the audio data represents the speech; obtain, from one or more speech-to-text models, text representing the speech; obtain, from one or more language models, text feature data based on the text; and provide the text feature data as input to the first machine-learning model to generate the first embedding.

Example 12 includes the device of Example 11, wherein the contextual encoder system includes the first machine-learning model interconnected with the second machine-learning model for two-way exchange of shared intermediate state data, and wherein the shared intermediate state data includes: the state data of the first machine-learning model which is shared with the second machine-learning model during generation of the second embedding; and second state data of the second machine-learning model which is shared with the first machine-learning model during generation of the first embedding.

Example 13 includes the device of any of Examples 1 to 12, wherein the first machine-learning model includes an encoder of a language transformer model and the second machine-learning model includes an encoder of an image transformer model.

Example 14 includes the device of any of Examples 1 to 13, wherein the one or more processors are configured to obtain scene feature data based on the scene data; and provide the scene feature data as input to the second machine-learning model to generate the second embedding.

Example 15 includes the device of any of Examples 1 to 14, wherein the one or more vehicle control signals include maneuvering signals.

Example 16 includes the device of Example 15, wherein the maneuvering signals include steering control signals, brake control signals, transmission control signals, acceleration control signals, or a combination thereof.

Example 17 includes the device of any of Examples 1 to 16, wherein the one or more vehicle control signals include controls signals for vehicle alert and communication systems.

Example 18 includes the device of any of Examples 1 to 17, wherein the scene sensors include one or more image sensors, one or more lidar sensors, one or more sonar sensors, one or more radar sensors, or a combination thereof.

Example 19 includes the device of any of Examples 1 to 18, wherein the one or more processors are integrated in the vehicle.

Example 20 includes the device of any of Examples 1 to 19 and further includes a modem configured to send a signal representing the vehicle control signals to the vehicle.

Example 21 includes the device of any of Examples 1 to 20 and further includes a modem configured to receive a signal representing the scene data, audio data representing the speech, or both, from one or more remote devices.

According to Example 22, a method includes obtaining, via a first machine-learning model of a contextual encoder system, a first embedding based on data representing speech that includes one or more commands for operation of a vehicle; obtaining, via a second machine-learning model of the contextual encoder system, a second embedding based on scene data from one or more scene sensors associated with the vehicle and based on state data of the first machine-learning model; and generating one or more vehicle control signals for the vehicle based on the first embedding and the second embedding.

Example 23 includes the method of Example 22, wherein at least one command of the one or more commands relates an action to be performed to a feature of a local context in which the vehicle is operating.

Example 24 includes the method of Example 22 or Example 23, wherein the first embedding corresponds to a semantic embedding and the second embedding corresponds to a text-grounded scene embedding.

Example 25 includes the method of any of Examples 22 to 24 and further includes generating a navigation feature embedding based on the first embedding and the second embedding, and wherein the one or more vehicle control signals are based on the navigation feature embedding.

Example 26 includes the method of Example 25, wherein generating the navigation feature embedding comprises: using one or more projection models to align the first and second embeddings to a shared space; and combining the aligned first and second embeddings to form the navigation feature embedding.

Example 27 includes the method of Example 26, wherein the one or more projection models include feedforward fully connected networks configured to modify dimensionality of the first embedding, the second embedding, or both.

Example 28 includes the method of any of Examples 25 to 27 and further includes generating a masked navigation feature embedding based on the navigation feature embedding and a contextual safety mask, and wherein the one or more vehicle control signals are based on the masked navigation feature embedding.

Example 29 includes the method of Example 28 and further includes generating, based on the first embedding and the second embedding, the contextual safety mask using a decoder of a transformer network.

Example 30 includes the method of any of Examples 22 to 29 and further includes determining a path plan for the vehicle based on the first embedding and the second embedding, and wherein the one or more vehicle control signals are based on the path plan.

Example 31 includes the method of any of Examples 22 to 30 and further includes obtaining commands for one or more controllers of the vehicle based on the first embedding and the second embedding, and wherein the one or more controllers are configured to apply control laws to determine the vehicle control signals based on the commands.

Example 32 includes the method of any of Examples 22 to 31 and further includes obtaining audio data captured by one or more microphones associated with the vehicle, wherein at least a portion of the audio data represents the speech; obtaining, from one or more speech-to-text models, text representing the speech; obtaining, from one or more language models, text feature data based on the text; and providing the text feature data as input to the first machine-learning model to generate the first embedding.

Example 33 includes the method of Example 32, wherein the contextual encoder system includes the first machine-learning model interconnected with the second machine-learning model for two-way exchange of shared intermediate state data, and wherein the shared intermediate state data includes: the state data of the first machine-learning model which is shared with the second machine-learning model during generation of the second embedding; and second state data of the second machine-learning model which is shared with the first machine-learning model during generation of the first embedding.

Example 34 includes the method of any of Examples 22 to 33, wherein the first machine-learning model includes an encoder of a language transformer model and the second machine-learning model includes an encoder of an image transformer model.

Example 35 includes the method of any of Examples 22 to 34 and further includes obtaining scene feature data based on the scene data; and providing the scene feature data as input to the second machine-learning model to generate the second embedding.

Example 36 includes the method of any of Examples 22 to 35, wherein the one or more vehicle control signals include maneuvering signals.

Example 37 includes the method of Example 36, wherein the maneuvering signals include steering control signals, brake control signals, transmission control signals, acceleration control signals, or a combination thereof.

Example 38 includes the method of any of Examples 22 to 37, wherein the one or more vehicle control signals include controls signals for vehicle alert and communication systems.

Example 39 includes the method of any of Examples 22 to 38, wherein the scene sensors include one or more image sensors, one or more lidar sensors, one or more sonar sensors, one or more radar sensors, or a combination thereof.

According to Example 40, a non-transitory computer-readable medium storing instructions executable by one or more processors to cause the one or more processors to obtain, via a first machine-learning model of a contextual encoder system, a first embedding based on data representing speech that includes one or more commands for operation of a vehicle; obtain, via a second machine-learning model of the contextual encoder system, a second embedding based on scene data from one or more scene sensors associated with the vehicle and based on state data of the first machine-learning model; and generate one or more vehicle control signals for the vehicle based on the first embedding and the second embedding.

Example 41 includes the non-transitory computer-readable medium of Example 40, wherein at least one command of the one or more commands relates an action to be performed to a feature of a local context in which the vehicle is operating.

Example 42 includes the non-transitory computer-readable medium of Example 40 or Example 41, wherein the first embedding corresponds to a semantic embedding and the second embedding corresponds to a text-grounded scene embedding.

Example 43 includes the non-transitory computer-readable medium of any of Examples 40 to 42, wherein the instructions cause the one or more processors to generate a navigation feature embedding based on the first embedding and the second embedding, and wherein the one or more vehicle control signals are based on the navigation feature embedding.

Example 44 includes the non-transitory computer-readable medium of Example 43, wherein, to generate the navigation feature embedding, the instructions cause the one or more processors to use one or more projection models to align the first and second embeddings to a shared space; and combine the aligned first and second embeddings to form the navigation feature embedding.

Example 45 includes the non-transitory computer-readable medium of Example 44, wherein the one or more projection models include feedforward fully connected networks configured to modify dimensionality of the first embedding, the second embedding, or both.

Example 46 includes the non-transitory computer-readable medium of any of Examples 43 to 45, wherein the instructions cause the one or more processors to generate a masked navigation feature embedding based on the navigation feature embedding and a contextual safety mask.

Example 47 includes the non-transitory computer-readable medium of Example 46, wherein the instructions cause the one or more processors to generate, based on the first embedding and the second embedding, the contextual safety mask using a decoder of a transformer network.

Example 48 includes the non-transitory computer-readable medium of any of Examples 40 to 47, wherein the instructions cause the one or more processors to determine a path plan for the vehicle based on the first embedding and the second embedding, and wherein the one or more vehicle control signals are based on the path plan.

Example 49 includes the non-transitory computer-readable medium of any of Examples 40 to 48, wherein the instructions cause the one or more processors to obtain commands for one or more controllers of the vehicle based on the first embedding and the second embedding, and wherein the one or more controllers are configured to apply control laws to determine the vehicle control signals based on the commands.

Example 50 includes the non-transitory computer-readable medium of any of Examples 40 to 49, wherein the instructions cause the one or more processors to obtain audio data captured by one or more microphones associated with the vehicle, wherein at least a portion of the audio data represents the speech; obtain, from one or more speech-to-text models, text representing the speech; obtain, from one or more language models, text feature data based on the text; and provide the text feature data as input to the first machine-learning model to generate the first embedding.

Example 51 includes the non-transitory computer-readable medium of Example 50, wherein the contextual encoder system includes the first machine-learning model interconnected with the second machine-learning model for two-way exchange of shared intermediate state data, and wherein the shared intermediate state data includes: the state data of the first machine-learning model which is shared with the second machine-learning model during generation of the second embedding; and second state data of the second machine-learning model which is shared with the first machine-learning model during generation of the first embedding.

Example 52 includes the non-transitory computer-readable medium of any of Examples 40 to 51, wherein the first machine-learning model includes an encoder of a language transformer model and the second machine-learning model includes an encoder of an image transformer model.

Example 53 includes the non-transitory computer-readable medium of any of Examples 40 to 52, wherein the instructions cause the one or more processors to obtain scene feature data based on the scene data; and provide the scene feature data as input to the second machine-learning model to generate the second embedding.

Example 54 includes the non-transitory computer-readable medium of any of Examples 40 to 53, wherein the one or more vehicle control signals include maneuvering signals.

Example 55 includes the non-transitory computer-readable medium of Example 54, wherein the maneuvering signals include steering control signals, brake control signals, transmission control signals, acceleration control signals, or a combination thereof.

Example 56 includes the non-transitory computer-readable medium of any of Examples 40 to 55, wherein the one or more vehicle control signals include controls signals for vehicle alert and communication systems.

Example 57 includes the non-transitory computer-readable medium of any of Examples 40 to 56, wherein the scene sensors include one or more image sensors, one or more lidar sensors, one or more sonar sensors, one or more radar sensors, or a combination thereof.

According to Example 58, an apparatus includes means for obtaining, via a first machine-learning model of a contextual encoder system, a first embedding based on data representing speech that includes one or more commands for operation of a vehicle; means for obtaining, via a second machine-learning model of the contextual encoder system, a second embedding based on scene data from one or more scene sensors associated with the vehicle and based on state data of the first machine-learning model; and means for generating one or more vehicle control signals for the vehicle based on the first embedding and the second embedding.

Example 59 includes the apparatus of Example 58, wherein at least one command of the one or more commands relates an action to be performed to a feature of a local context in which the vehicle is operating.

Example 60 includes the apparatus of Example 58 or Example 59, wherein the first embedding corresponds to a semantic embedding and the second embedding corresponds to a text-grounded scene embedding.

Example 61 includes the apparatus of any of Examples 58 to 60 and further includes means for generating a navigation feature embedding based on the first embedding and the second embedding, and wherein the one or more vehicle control signals are based on the navigation feature embedding.

Example 62 includes the apparatus of Example 61, wherein the means for generating the navigation feature embedding is configured to use one or more projection models to align the first and second embeddings to a shared space; and combine the aligned first and second embeddings to form the navigation feature embedding.

Example 63 includes the apparatus of Example 62, wherein the one or more projection models include feedforward fully connected networks configured to modify dimensionality of the first embedding, the second embedding, or both.

Example 64 includes the apparatus of any of Examples 61 to 63 and further includes means for generating a masked navigation feature embedding based on the navigation feature embedding and a contextual safety mask, and wherein the one or more vehicle control signals are based on the masked navigation feature embedding.

Example 65 includes the apparatus of Example 64 and further includes means for generating, based on the first embedding and the second embedding, the contextual safety mask using a decoder of a transformer network.

Example 66 includes the apparatus of any of Examples 58 to 65 and further includes means for determining a path plan for the vehicle based on the first embedding and the second embedding, and wherein the one or more vehicle control signals are based on the path plan.

Example 67 includes the apparatus of any of Examples 58 to 66 and further includes means for obtaining commands for one or more controllers of the vehicle based on the first embedding and the second embedding, and wherein the one or more controllers are configured to apply control laws to determine the vehicle control signals based on the commands.

Example 68 includes the apparatus of any of Examples 58 to 67 and further includes means for obtaining audio data captured by one or more microphones associated with the vehicle, wherein at least a portion of the audio data represents the speech; means for obtaining, from one or more speech-to-text models, text representing the speech; means for obtaining, from one or more language models, text feature data based on the text; and means for providing the text feature data as input to the first machine-learning model to generate the first embedding.

Example 69 includes the apparatus of Example 68, wherein the contextual encoder system includes the first machine-learning model interconnected with the second machine-learning model for two-way exchange of shared intermediate state data, and wherein the shared intermediate state data includes: the state data of the first machine-learning model which is shared with the second machine-learning model during generation of the second embedding; and second state data of the second machine-learning model which is shared with the first machine-learning model during generation of the first embedding.

Example 70 includes the apparatus of any of Examples 58 to 69, wherein the first machine-learning model includes an encoder of a language transformer model and the second machine-learning model includes an encoder of an image transformer model.

Example 71 includes the apparatus of any of Examples 58 to 70, further includes means for obtaining scene feature data based on the scene data; and means for providing the scene feature data as input to the second machine-learning model to generate the second embedding.

Example 72 includes the apparatus of any of Examples 58 to 71, wherein the one or more vehicle control signals include maneuvering signals.

Example 73 includes the apparatus of Example 72, wherein the maneuvering signals include steering control signals, brake control signals, transmission control signals, acceleration control signals, or a combination thereof.

Example 74 includes the apparatus of any of Examples 58 to 73, wherein the one or more vehicle control signals include controls signals for vehicle alert and communication systems.

Example 75 includes the apparatus of any of Examples 58 to 74, wherein the scene sensors include one or more image sensors, one or more lidar sensors, one or more sonar sensors, one or more radar sensors, or a combination thereof.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
memory configured to store scene data from one or more scene sensors associated with a vehicle; and
one or more processors configured to:
obtain, via a first machine-learning model of a contextual encoder system, a first embedding based on data representing speech that includes one or more commands for operation of the vehicle;
obtain, via a second machine-learning model of the contextual encoder system, a second embedding based on the scene data and based on state data of the first machine-learning model; and
generate one or more vehicle control signals for the vehicle based on the first embedding and the second embedding.

2. The device of claim 1, wherein at least one command of the one or more commands relates an action to be performed to a feature of a local context in which the vehicle is operating.

3. The device of claim 1, wherein the first embedding corresponds to a semantic embedding and the second embedding corresponds to a text-grounded scene embedding.

4. The device of claim 1, wherein the one or more processors are configured to generate a navigation feature embedding based on the first embedding and the second embedding, and wherein the one or more vehicle control signals are based on the navigation feature embedding.

5. The device of claim 4, wherein, to generate the navigation feature embedding, the one or more processors are configured to:
use one or more projection models to align the first and second embeddings to a shared space; and
combine the aligned first and second embeddings to form the navigation feature embedding.

6. The device of claim 5, wherein the one or more projection models include feedforward fully connected networks configured to modify dimensionality of the first embedding, the second embedding, or both.

7. The device of claim 4, wherein the one or more processors are configured to generate a masked navigation feature embedding based on the navigation feature embedding and a contextual safety mask.

8. The device of claim 7, wherein the one or more processors are configured to generate, based on the first embedding and the second embedding, the contextual safety mask using a decoder of a transformer network.

9. The device of claim 1, wherein the one or more processors are configured to:
obtain audio data captured by one or more microphones associated with the vehicle, wherein at least a portion of the audio data represents the speech;
obtain, from one or more speech-to-text models, text representing the speech;
obtain, from one or more language models, text feature data based on the text; and
provide the text feature data as input to the first machine-learning model to generate the first embedding.

10. The device of claim 9, wherein the contextual encoder system includes the first machine-learning model interconnected with the second machine-learning model for two-way exchange of shared intermediate state data, and wherein the shared intermediate state data includes:
the state data of the first machine-learning model which is shared with the second machine-learning model during generation of the second embedding; and
second state data of the second machine-learning model which is shared with the first machine-learning model during generation of the first embedding.

11. The device of claim 1, wherein the first machine-learning model includes an encoder of a language transformer model, and the second machine-learning model includes an encoder of an image transformer model.

12. The device of claim 1, wherein the one or more processors are configured to:
determine scene feature data based on the scene data; and
provide the scene feature data as input to the second machine-learning model to generate the second embedding.

13. The device of claim 1, wherein the one or more vehicle control signals include maneuvering signals including steering control signals, brake control signals, transmission control signals, acceleration control signals, or a combination thereof.

14. The device of claim 1, wherein the one or more vehicle control signals include controls signals for vehicle alert and communication systems.

15. The device of claim 1, wherein the scene sensors include one or more image sensors, one or more lidar sensors, one or more sonar sensors, one or more radar sensors, or a combination thereof.

16. The device of claim 1, wherein the one or more processors are integrated in the vehicle.

17. The device of claim 1, further comprising a modem configured to send a signal representing the vehicle control signals to the vehicle.

18. The device of claim 1, further comprising a modem configured to receive a signal representing the scene data, audio data representing the speech, or both, from one or more remote devices.

19. A method comprising:
obtaining, via a first machine-learning model of a contextual encoder system, a first embedding based on data representing speech that includes one or more commands for operation of a vehicle;
obtaining, via a second machine-learning model of the contextual encoder system, a second embedding based on scene data from one or more scene sensors associated with the vehicle and based on state data of the first machine-learning model; and
generating one or more vehicle control signals for the vehicle based on the first embedding and the second embedding.

20. The method of claim 19, wherein at least one command of the one or more commands relates an action to be performed to a feature of a local context in which the vehicle is operating.

21. The method of claim 19, further comprising:
using one or more projection models to align the first and second embeddings to a shared space;
combining the aligned first and second embeddings to form a navigation feature embedding;
generating a contextual safety mask based on the navigation feature embedding; and
generating a masked navigation feature embedding based on the navigation feature embedding and the contextual safety mask, wherein the one or more vehicle control signals are based on the masked navigation feature embedding.

22. The method of claim 19, further comprising determining a path plan for the vehicle based on the first embedding and the second embedding, and wherein the one or more vehicle control signals are based on the path plan.

23. The method of claim 19, further comprising obtaining commands for one or more controllers of the vehicle based on the first embedding and the second embedding, and wherein the one or more controllers are configured to apply control laws to determine the vehicle control signals based on the commands.

24. The method of claim 19, further comprising:
obtaining audio data captured by one or more microphones associated with the vehicle, wherein at least a portion of the audio data represents the speech;
obtaining, from one or more speech-to-text models, text representing the speech;
obtaining, from one or more language models, text feature data based on the text; and
providing the text feature data as input to the first machine-learning model to generate the first embedding.

25. The method of claim 24, wherein the contextual encoder system includes the first machine-learning model interconnected with the second machine-learning model for two-way exchange of shared intermediate state data, and wherein the shared intermediate state data includes:
the state data of the first machine-learning model which is shared with the second machine-learning model during generation of the second embedding; and
second state data of the second machine-learning model which is shared with the first machine-learning model during generation of the first embedding.

26. A non-transitory computer-readable medium storing instructions executable by one or more processors to cause the one or more processors to:
obtain, via a first machine-learning model of a contextual encoder system, a first embedding based on data representing speech that includes one or more commands for operation of a vehicle;
obtain, via a second machine-learning model of the contextual encoder system, a second embedding based on scene data from one or more scene sensors associated with the vehicle and based on state data of the first machine-learning model; and
generate one or more vehicle control signals for the vehicle based on the first embedding and the second embedding.

27. The non-transitory computer-readable medium of claim 26, wherein at least one command of the one or more commands relates an action to be performed to a feature of a local context in which the vehicle is operating.

28. The non-transitory computer-readable medium of claim 26, wherein the instructions cause the one or more processors to:
use one or more projection models to align the first and second embeddings to a shared space;
combine the aligned first and second embeddings to form a navigation feature embedding;
generate a contextual safety mask based on the navigation feature embedding; and
generate a masked navigation feature embedding based on the navigation feature embedding and the contextual safety mask, wherein the one or more vehicle control signals are based on the masked navigation feature embedding.

29. The non-transitory computer-readable medium of claim 26, wherein the instructions cause the one or more processors to:
obtain audio data captured by one or more microphones associated with the vehicle, wherein at least a portion of the audio data represents the speech;
obtain, from one or more speech-to-text models, text representing the speech;
obtain, from one or more language models, text feature data based on the text; and
provide the text feature data as input to the first machine-learning model to generate the first embedding.

30. An apparatus comprising:
means for obtaining, via a first machine-learning model of a contextual encoder system, a first embedding based on data representing speech that includes one or more commands for operation of a vehicle;
means for obtaining, via a second machine-learning model of the contextual encoder system, a second embedding based on scene data from one or more scene sensors associated with the vehicle and based on state data of the first machine-learning model; and
means for generating one or more vehicle control signals for the vehicle based on the first embedding and the second embedding.
